(19) United States
(12) Patent Application Publication
(10) Pub. No.: US 2011/0035259 A1
(43) Pub. Date: Feb. 10, 2011

(54) COST AND PARTICIPATION MODELS FOR EXCHANGE THIRD-PARTY INTEGRATION IN ONLINE ADVERTISING

(75) Inventors: Shirshanka Das, Santa Clara, CA (US); Bhaskar Ghosh, Palo Alto, CA (US); Dong Wang, Saratoga, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/537,429

(22) Filed: Aug. 7, 2009

(51) Int. Cl. G06Q 10/00; G06Q 30/00

(52) U.S. Cl. 705/10

(57) ABSTRACT

A modeling system to evaluate cost-based viability of a real-time, auction-based advertising system with third-party integration includes an exchange server configured to receive advertising bids, create bid requests to third-party entities based thereon, and select a winning bid from responses to the requests. A computer, coupled with the exchange server: computes a plurality of valid paths from publishers to and from the third-party entities through the exchange server; estimates server and network costs, including fixed hardware costs and variable operational costs, amortized over a predetermined period of time, based on a number of average queries per second (QPS) transmitted at different portions of the valid paths; compares current periodic fees paid by the third-party entities to the amortized costs, to determine cost-based system viability; and determines updates, if needed, to the periodic fees based on the plurality of costs to maintain cost-based system viability.

### RELATED APPLICATIONS

Applications related to the present application include U.S. application Ser. No. 12/398,841 titled Architecture for an Online Advertisement Bidding System, filed Mar. 5, 2009, and U.S. application Ser. No. 12/398,877, titled A Bid Gateway Architecture for an Online Advertisement Bidding System, filed Mar. 5, 2009, both of which are herein incorporated by reference.

### BACKGROUND

1. Technical Field

The disclosed embodiments relate to the field of advertising systems, and more particularly, to a modeling system and methods that evaluate and ensure cost-based viability of a real-time, auction-based advertising system with third-party integration.

2. Related Art

Electronic exchanges, including online auctions, have proliferated along with the Internet. These electronic exchanges aim to provide a high degree of trading efficiency by bringing together a large number of buyers and sellers. Such exchanges are typically focused on directly matching the bids and offers of buyers and sellers. Conventional transactions on these exchanges are typically between (i) buyers and sellers, (ii) intermediaries (e.g., brokers, which may be buyers or sellers), or (iii) buyers or sellers and their intermediaries.

The proliferation of Internet activity has also generated tremendous growth for advertising on the Internet. Typically, advertisers (e.g., buyers of advertisement (“ad”) space) and online publishers (sellers of ad space) have agreements with one or more advertising networks (ad networks), which serve a banner or ad of an advertiser across multiple publishers, and concomitantly provide each publisher access to a large number of advertisers. Ad networks, which may also manage payment and reporting, might also attempt to target certain Internet users with particular advertisements to increase the likelihood that the user will take an action with respect to the ad. From the perspective of the advertiser, effective targeting leads to a higher return on investment (ROI).

Online advertising markets exhibit undesirable inefficiencies when buyers and sellers are unable to transact. For instance, although a publisher may subscribe to many ad networks, and one or more of those ad networks may transact inventory with other ad networks, only one of the ad networks to which the publisher is subscribed may be involved in selling (e.g., auctioning) a given ad space for the publisher. The publisher, or a gatekeeper used by the publisher, selects or prioritizes which ad network or advertiser having a direct agreement with the publisher serves the impression for a given ad request.

Fluctuation in amounts paid for bids on ad queries (or “ad calls”) is also inherent in the online advertising markets as supply of advertising inventory space on publisher Web sites changes along with advertiser demand for that inventory. Accordingly, if the amount paid by all advertisers can be averaged and trends can be tracked to predict future revenue, it would also be helpful to track the cost-based viability of a real-time, auction-based advertising system that includes such fluctuations when considering projected revenue in light of projected costs.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the present disclosure. In the drawings, like-referenced numerals designate corresponding parts throughout the different views.

FIG. 1 illustrates one embodiment of an ad delivery system.

FIG. 2 illustrates another embodiment of an ad delivery system.

FIG. 3 illustrates an advertisement exchange system according to some embodiments.

FIG. 4 illustrates another embodiment of an advertisement exchange system.

FIG. 5 illustrates a high-level process for generating bid requests per opportunity according to some embodiments.

FIG. 6 is a flow diagram illustrating a process for generating a bid response in accordance with some embodiments.

FIG. 7 is a flow diagram illustrating a process for selecting a bid and/or an advertisement.

FIG. 8 is a block diagram illustrating one embodiment for implementing a bid gateway in an online advertising system.

FIG. 9 is a block diagram illustrating some information stored and used by the bid gateway of FIG. 8.

FIG. 10 is a block diagram illustrating a computer architecture for the bid gateway of FIG. 8, in accordance with some embodiments.

FIG. 11 illustrates an exchange system of some embodiments in further detail.

FIG. 12 illustrates another embodiment of an advertising exchange system with additional features.

FIG. 13 is a block diagram illustrating a rate limiter for bid requests in accordance with some embodiments.

FIG. 14 illustrates some ramping profiles.

FIG. 15 illustrates an advertising bid system that implements server-side caching.

FIG. 16 illustrates a bid-per-opportunity advertising system that includes client and/or browser side (local) caching.

FIG. 17 illustrates an advertising system for collocation of integrator network devices within a collocation facility.

FIG. 18 illustrates one embodiment of a network environment for operation of the online advertisement system of the present disclosure.

FIG. 19 illustrates a high-level block diagram of a general-purpose computer system.

FIG. 20 is a flow diagram of a method for evaluating cost-based viability of a real-time, auction-based advertising system with third-party integration.

### DETAILED DESCRIPTION

By way of introduction, disclosed below is a modeling system and methods that evaluate and ensure cost-based viability of a real-time, auction-based advertising system with third-party integration. Using an exchange user interface of the system, a third-party network sets up an advertiser entity and an associated advertisement and desired targeting constraints. Accordingly, the system will also be referred to as an exchange system. A traffic cache file is created and read by an ad server (or exchange server) to represent the exchange data model. An exchange entity or company owns the exchange server.

Third-party integration of the system allows independent, non-exchange networks or advertisers to bid statically on inventory of publishers while third-party, exchange participants engage in bidding dynamically, in real time. When an ad query (or “ad call”) is generated in response to a user impression on a publisher Web page, the ad server computes all valid paths from the publisher to the third-party entities participating in the exchange data model. The ad server then generates requests for bids that are sent out to qualifying third-party entities, which can include one or more third-party networks. The system subsequently receives bids for filling that impression with an ad from the third-party entities—dynamically from exchange participants and statically from non-exchange participants—and determines a winner based on various business rules and targeting constraints, such as demographic and geographic restrictions. Ultimately, the system delivers the ad from the winning bidder to the Web page to fulfill the ad query, thus giving the user a chance to view and take action with respect to the delivered advertisement.

Because the auction-based advertising system joins together large numbers of publishers and advertisers, a significant amount of computer hardware is needed to run the exchange system in real time. This includes the servers and network components, such as routers, switches, etc., as discussed in detail below. Of course, operational costs, including maintenance expenses, are associated with this computer hardware. Furthermore, bandwidth costs are associated with receiving ad queries, passing on bid requests, receiving bids, and ultimately delivering advertisements. These bandwidth costs vary depending on whether packets of ad queries and bids, etc., are passed within a co-location facility (or data center or server farm), or are passed outside that facility across integrator networks and to third-party entities. Accordingly, aggregating all valid paths throughout the networked exchange system creates a non-linear problem that is more easily solved by analyzing portions of the valid paths separately, and then averaging latencies together.

In order to be viable as a real-time, auction-based advertising system, the backbone of the system hardware needs to support demands placed there. As discussed above, these demands fluctuate with advertising inventory supply and advertiser demand within the advertising marketplace. Accordingly, the present disclosure proposes a modeling system and methods to track a plurality of costs such as those mentioned above, and after amortization of those costs over a predetermined period of time, to compare them with trending revenue obtained from periodic advertiser fees. The modeling system may then recommend as-needed updates to the periodic advertiser fees, to ensure that the auction-based advertising exchange remains viable. The modeling system may also recommend when to add to computer hardware, such as adding servers, routers, switches, etc., to keep pace with growing demands placed on the exchange system and integrate the amortized costs of the additional hardware into the viability analysis.

The embodiments of the advertising system are described using a number of terms. In order to aid in clarity, some definitions of the terms used to describe these embodiments follow. However, these terms define general concepts, and are not to be construed narrowly. A publisher is a Web site that has inventory for the delivery of advertisements. As such, advertisements are displayed on the Web pages of the publisher's Web site. Users are generally those individuals who access Web pages through use of a browser. However, the term “user” may also be applied to describe entities that use the advertising exchange system, such as users that access an application on the advertising exchange system to set parameters. Various participants of the advertising exchange system are referred to as “entities.” Thus, the term “entity” is generally used to describe any number of participants of the advertising exchange system. Those participants include advertisers, publishers, advertising networks, and integrator networks.

An advertising network typically integrates entities, such as advertisers and publishers. An advertising network typically operates in conjunction with advertisers and publishers in order to deliver ads from one or more advertisers to Web pages of one or more publishers. For example, Yahoo! Inc, the assignee of the present application, operates such an advertising network.

An integrator network entity is a participant of the advertising exchange system that represents or integrates one or more entities on the advertising exchange system (e.g., advertisers, publishers, advertising networks, etc.). For example, an integrator network may represent advertisers on the advertising exchange system in order to deliver advertisements to publishers, advertising networks, and other integrator networks. In some embodiments, the integrator networks are referred to as the “users” of the advertising exchange system. The integrated networks may include third-party agents who operate on behalf of or are part of the integrator network. The term “third-party agent” is used to generally describe an agent or customer who participates in transactions on the advertising exchange system. Similarly, the term “third-party recipient” is used to describe a user or participant of the advertising exchange system who receives information from the system, such as bid requests. However, the terms “integrator networks,” “third-party agents,” and “third-party recipients” are intended to represent a broad class of entities, e.g., “third-party entities,” including publishers, advertisers, and networks, as well as the agents who represent them, all of which operate on the advertising exchange system.

One of ordinary skill will also recognize certain abbreviations such as cost per impression, Cost Per Mille or cost per 1,000 impressions (CPM), cost per click (CPC), cost per acquisition (CPA), and effective CPM (eCPM).

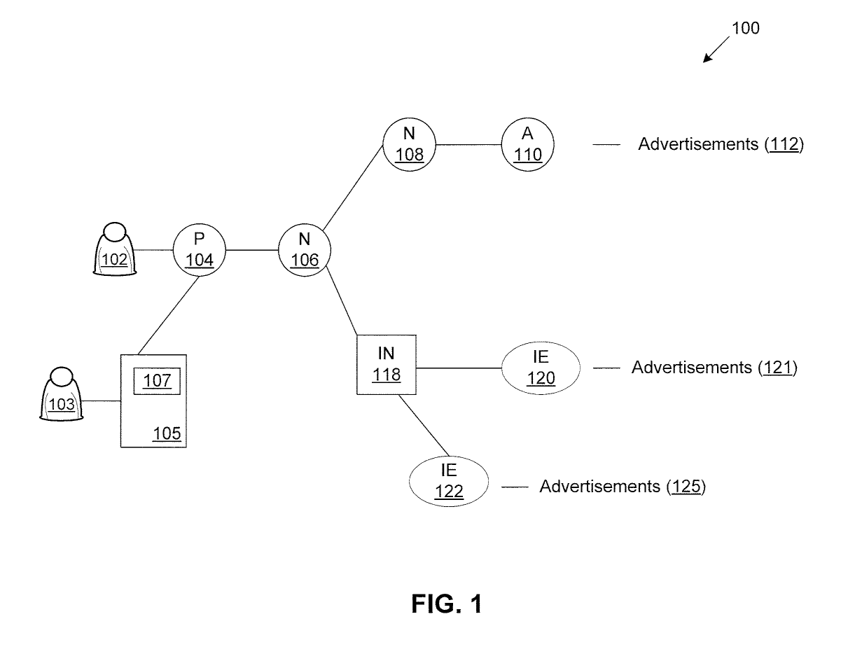

FIG. 1 illustrates one embodiment of an ad delivery system 100. As shown in FIG. 1, the system 100 includes a variety of entities such as users 102 and 103, one or more publishers 104, networks 106 and 108, and/or advertisers 110. The system 100 further includes one or more integrator networks (IN) 118 that have one or more integrated entities (IE) 120 and 122. The various entities, including users, publishers, networks, advertisers, integrator networks, and integrated entities illustrated in FIG. 1 are merely exemplary, and one of ordinary skill will recognize that the system 100 may include large numbers of entities. Moreover, the various entities are coupled together in different advantageous configurations such as, for example, the exemplary configuration illustrated in FIG. 1.

The user 103 accesses information and/or content provided by the publisher 104. One form of access may include a browser 105 that has inventory locations 107 for the presentation of advertising. In one embodiment, an ad query is generated that requests an advertisement, from advertisements 112, 121 and 125, for placement with the inventory location 107. The corresponding advertisement may be delivered to publisher 104 by one or more networks. In one example, the network 106 is coupled with the publisher 104, and the network 108 is coupled with the advertiser 110. For this example, the networks 106 and 108 are coupled with each other. Herein, the phrase “coupled with” is defined to mean directly connected to or indirectly connected through one or more intermediate components. Such intermediate components may include both hardware and software-based components. The advertiser 110 generally has one or more ad campaigns, each including one or more advertisements 112 that the advertiser 110 wishes to place with the inventory of publishers such as the inventory location 107 of the publisher 104, which is presented to the user 103 via the browser application 105.

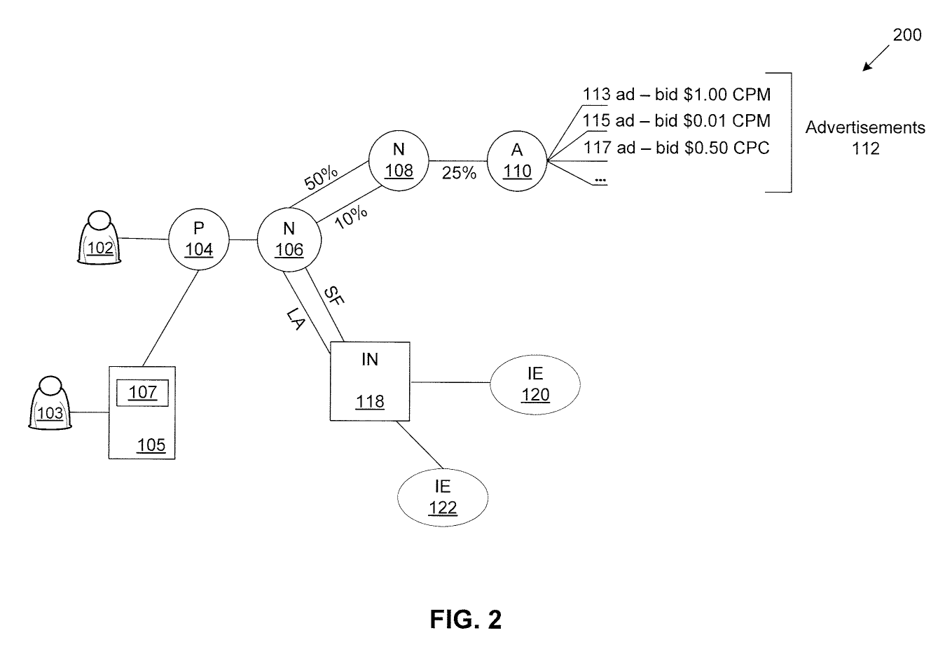

FIG. 2 illustrates another embodiment of an ad delivery system 200. For this example, a number of advertisements 112 generally each have an associated bid that the advertiser 110 will pay for the placement of the advertisement with the inventory and for presentation to the user(s). For this example, an advertisement 113 has a bid of $1.00 cost per thousand page impressions (CPM), an advertisement 115 has a bid of $0.01 CPM, and an advertisement 117 has a bid of $0.50 cost per click (CPC). One of ordinary skill will recognize different types of bids such as, for example, CPM, CPC, cost per action (CPA), and others. Some systems normalize the ad bids to CPM.

For the example illustrated in FIG. 2, the entities along the chain of distribution for the advertisements have various revenue-sharing agreements. In this example, the network 108 has a 25% revenue-sharing agreement with the network 106 for fees paid by the advertiser 110. Similarly, the network 106 has 50% and 10% revenue-sharing agreements with the publisher 104 for fees paid to the network 106 by way of the network 108. The multiple revenue-sharing agreements among entities may be for different campaigns and/or for targeting different segments of users. For example, the 50% revenue-sharing agreement between networks 108 and 106 may be used to target a user segment which includes males under 40-years old, who have an interest in sports. In another example illustrated in FIG. 2, the 10% revenue-sharing agreement may be used to target females, over 30-years old, who have an interest in gardening. For these examples, network 108 delivers users of the target segment to network 106, and network 106 is the exclusive representative of the publisher 104. One of ordinary skill will recognize many different payment and/or targeting schemes.

Alternatively, or in conjunction with the embodiments described above, some embodiments direct an ad query for the inventory 107 to an integrator network 118. In one example, the ad query is passed from the network 106 to the integrator network 118 with additional information, such as a geographic location for the destination of the advertisement. In the illustration of FIG. 2, one ad query may have a destination of San Francisco (SF), while another ad query may have a destination of Los Angeles (LA). Based on the ad query and information, the integrator network 118 selectively responds to ad queries for, or on behalf of, one or more of its integrated entities 120 and/or 122. The integrated entities 120 and 122 generally include third-party entities, such as advertisers who transact on the exchange by using an intermediary, such as the integrator network 118.

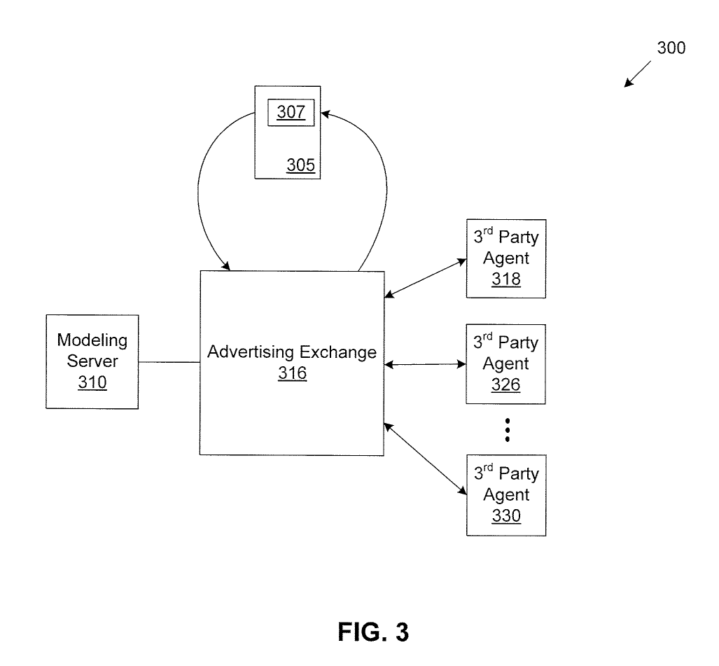

FIG. 3 illustrates an advertisement exchange system 300 according to some embodiments. As shown in FIG. 3, the system 300 includes a browser 305 that presents content including advertising inventory 307, and generates an ad query to an advertising exchange 316 (also referred to as an ad server 316). The advertising exchange 316 conducts an auction to present advertisements in response to the ad query on a per opportunity basis. As such, the advertising exchange 316 conducts an auction with a plurality of third-party agents, represented as third-party agents 318, 326, and 330 in FIG. 3.

Any number of third-party agents or entities may participate in the advertising exchange system 300. As described above, a third-party agent may include an integrator network, an advertiser, or other network. To conduct an auction, the advertising exchange 316 submits requests for bids to third-party agents who qualify to deliver the ad to the inventory location 307. In one embodiment, the eligibility is determined based on one or more business rules, specified by the publisher, a network, or the advertiser. In response, the third-party agents (318, 326, and 330) respond by generating a bid for the advertising opportunity, or alternatively, generate no bid for the opportunity. The advertising exchange collects the bids and selects a bid to “win” the auction, based on one or more predetermined criteria. An advertisement creative, corresponding to the auction winner, is then delivered to the user browser 305 for display in the inventory space 307.

The system 300 may also include a modeling server 310, which can be any computer with sufficient processing power and coupled with the advertising exchange 316, to compute valid paths through the system 300 and to estimate a plurality of server and network costs, amortized over a predetermined period of time. That a path is valid means that the end points are coupled together through one or more properly functioning network or server components. The amortization period, as an example, is commonly chosen to be three years. The costs are determined according to a number of average queries per second (QPS) transmitted at different portions of the valid paths, which will be discussed in more detail below, as the potential complexities of those valid paths are explained with reference to various embodiments. The modeling server 310 may also compare current periodic fees paid by third-party entities, which influences advertising revenue, with the amortized costs to determine cost-based system viability. The modeling server 310 may also update, as needed, the periodic fees based on the amortized costs, to maintain cost-based system viability. One of ordinary skill will appreciate that the modeling server (or computer) 310 may be integrated within the advertising exchange 316 in terms of hardware and/or software such that their respective functionalities are shared.

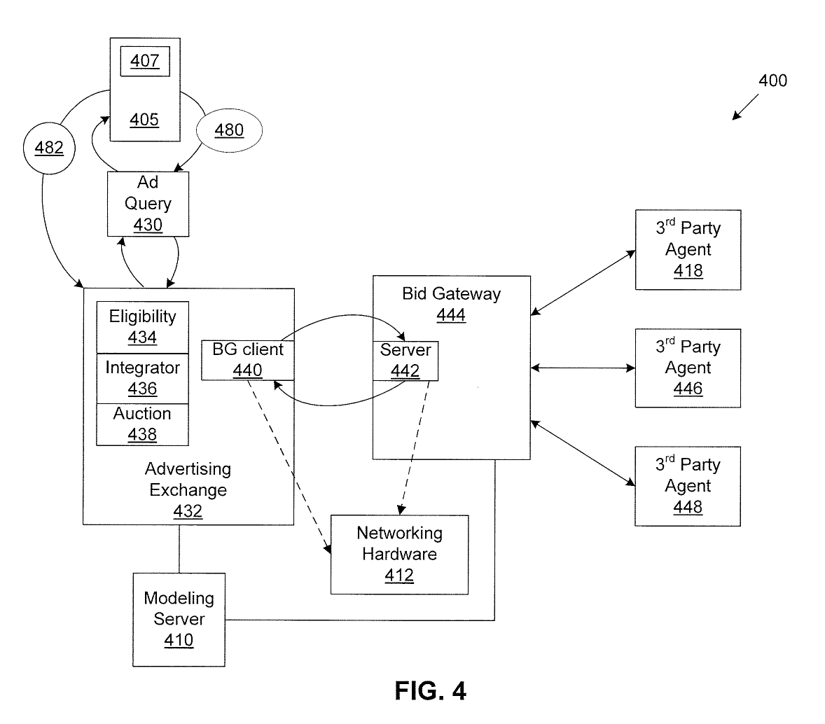

FIG. 4 illustrates another embodiment of an advertisement exchange system 400. The system 400 includes a browser 405 that presents content, including advertising inventory 407, and generates an ad query 430 to the advertising exchange 432. For this embodiment, the system 400 includes a modeling server 410, networking hardware 412, an advertising exchange 432, a bid gateway 444, and one or more third-party agents 418, 446, and 448. As mentioned above, the browser 405 and/or inventory 407 generate requests for the presentation of advertisements to a user at various times. One such type of request is in the form of an ad query 430 to the advertising exchange 432. The ad query 430 generally includes a variety of different types of information. In some embodiments, the ad query 430 may include a conventional-type ad query for an ad campaign, for a creative advertisement that is supplied by a conventional network entity and/or by and advertiser. The advertising exchange 432 is further capable of receiving additional types of information and/or requests such as, for example, Advertising Publisher's Exchange (APEX) information 480, RightMedia information 482, and/or alternative ad queries such as federated ad queries (FAQ), which contain additional information and/or complexity.

For this embodiment, the networking hardware 412 is coupled with both the advertising exchange 432 and the bid gateway 444, and may include routers, switches, hubs, or other types of networking hardware to pass network packets between the advertising exchange 432 and the bid gateway 444. The advertising exchange 432 includes several modules that provide a variety of functionalities such as an eligibility module 434, an integrator module 436, an auction module 438, and a bid gateway (BG) client module 440.

The eligibility module 434 determines which entities, including integrator networks and/or integrated entities, are eligible to respond to a particular ad query or to receive a request for an ad bid. The determination may be based on targeting information regarding, for instance, the user, the inventory, the browser, and/or the publisher, which are the destination of the requested advertisement. The eligibility module 434 preferably receives targeting, bidding, and eligibility information from the ad query 430, and passes information regarding the entities eligible to bid for the placement of advertising in response to the ad query 430. Some additional criteria for eligibility that may be used by the eligibility module 434 include knowledge regarding which entities (e.g., integrator networks) are enabled to receive a certain volume of bid requests for a certain period of time, and that have not reached their maximum quota of bid requests for the time period, or that have advertisements directed toward certain user segments, for example, of which the particular targeted user is a member of such user segments.

Once eligible entities are determined for bidding, the integrator module 436 communicates the information to the bid gateway 444. As explained more fully below, the bid gateway generates one or more ad bid requests for each eligible entity, such as the third-party agents 418, 446, 448. In one embodiment, the integrator module 436 uses a client-server approach, such as via the bid gateway client module 440 and a bid gateway server module 442, to communicate with the bid gateway 444. Of course, these communication paths may be further facilitated by the networking hardware 412 coupled between the advertising exchange 432 and the bid gateway 444.

The bid gateway 444 further transmits the generated ad bid requests to the appropriate entity or entities such as one or more of the third-party agents 418, 446, 448, and waits for responses to the bid requests. Preferably, the bid gateway 444 waits for only a predetermined period of time (e.g., less than 100 milliseconds), such that the bid request-response process does not add significantly to the overall round trip time for ad query/bid request and/or delivery. A third-party agent 418, 446, 448, such an integrator network, may respond to an ad bid request with a message containing a particular advertisement, and a monetary bid amount for the placement of the particular advertisement with the inventory, in response to the particular ad query for the particular user and/or the particular publisher, at the time of the ad query.

Preferably, the selected integrator networks (e.g., third-party agents) respond to the bid request within a predetermined amount of time. In some embodiments, the round trip time for the bid request and the bid response, from the bid gateway 444 to and from each responding eligible entity (e.g., integrator networks) is less than about 100 milliseconds, and in some cases the total round trip time for the ad query and ad delivery and/or presentation is less than about 500 milliseconds, with about a 200 millisecond average.

Alternatively, the integrator network (e.g., third-party agents 418, 446, 448) may respond with a message indicating “no bid,” or not respond at all within the allowable time period for response. The bid gateway 444 transmits any ad bids that are within the allowable response period to the integrator module 436. The auction module 438 then uses the ad bids to determine a winner among the received bid responses. In one embodiment, the auction module 438 executes a plurality of business rules to select the winning bid. The business rules may use any type of criteria to select a bid, including price of the bid. Accordingly, an advertisement is selected from the received bid responses, and is then delivered or served to the inventory location 407, and/or the user of the browser 405.

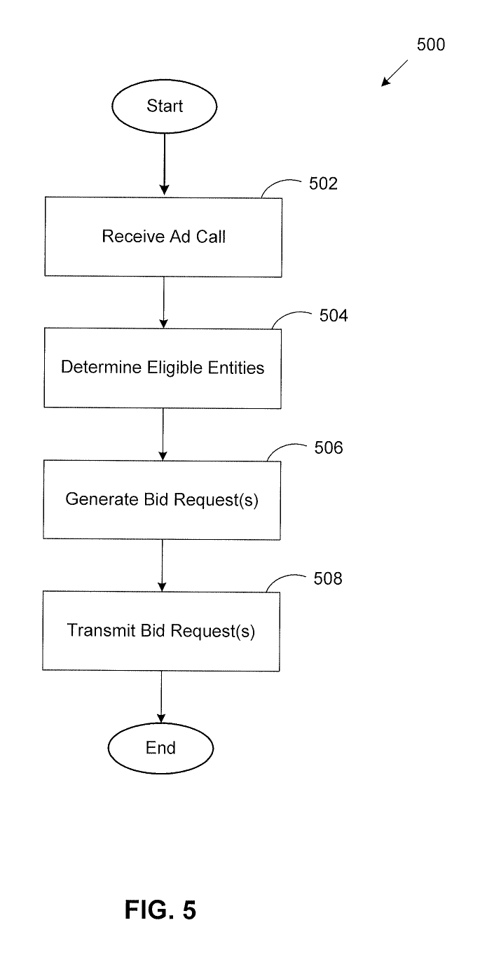

The advertising exchange 432 may perform a variety of additional or optional functions and/or services. For instance, the appropriate entities may be compensated according to their respective agreements, and the various activities of the system 400 may be logged for the exchange. Furthermore, the modeling server 410 (and/or the advertising exchange 432) may be coupled with the advertising exchange 432 and/or the bid gateway 444, to track movement of network packets through a plurality of valid paths within the system 400. Based on a number of average queries per second (QPS) transmitted at different portions of the valid paths, the modeling server 410 can estimate a plurality of server and network costs, including fixed hardware costs and variable operational costs, amortized over a predetermined period of time, as discussed above. Furthermore, the modeling server 410 may calculate latencies through the portions of valid paths to determine bandwidth costs. In the following description dealing with FIGS. 5-7, specific steps taken in processes of the auction-based, real-time advertising system 400 are explained in more detail.

FIG. 5 illustrates a high-level process for generating bid requests per opportunity according to some embodiments. As shown in FIG. 5, the process 500 begins when an ad call is received at block 502. In some embodiments, the ad call is received by an advertising exchange (or ad server) when a user interacts with a Web browser such as when the user visits publisher Web pages having inventory for the placement of advertisements. In some embodiments, the ad query is a federated-type ad query that may be distributed to various entities, including conventional networks, as well as integrator networks, for integrating third-parties into the advertising exchange system. Third-party entities that are integrated into the exchange by an integrator network (IN) may be referred to herein simply as integrated entities (IE). Generally, several operations are performed when the ad query is received, such as validation that the ad query has a proper format and/or is received from a reliable source. Moreover, traffic, flow, and/or rate control of many ad queries is performed, and/or various exchange data are looked up or retrieved, such as user and/or browser data, by using a user data base (UDB), and the like.

Continuing with the process flow of FIG. 5, a set of eligible entities is determined at block 504. The determination of the eligible entities may be based on the capabilities of the entities, and/or the selected preferences of the entities. For instance, an entity may be eligible to receive a bid request for the particular ad query based on the user targeting needs of the entity. In some embodiments, the advertising exchange effectively utilizes a directed graph. The directed graph defines eligible paths among entities based on one or more criteria. The criteria may be specified by an advertiser or an entity (e.g., publisher). For example, the directed graph may specify, between two entities, a path for traffic that originated from a geographical region, such as Los Angeles. For this example, an entity may place a constraint that they are only interested in bidding on traffic from Los Angeles. As such, the entity is only eligible to receive a bid request if the traffic originated from Los Angeles. In addition, the publisher, with the inventory, may define a list of rules that define the criteria for the advertisement. Furthermore, the creative for an advertiser or entity must be compatible with the inventory. For example, the size of the inventory must coincide with the size of the creative. The publisher may further limit the type of the creative, such as specifying that the creative cannot be flash. Eligibility may be further based on a competitive exclusion or the rules of the exchange. In one implementation, a module of the advertising exchange module determines eligibility.

Once eligible entities are determined, bid request(s) are generated for the eligible entity(s) at block 506. In some embodiments, bid requests are customized for each eligible entity. The bid request may further include additional information to aid the eligible entities in determining how to respond to the bid request (e.g., whether to bid, how much to bid, which advertisement(s) to select for presentation). The information may include, for example, details regarding the publisher, the inventory, the browser, and/or the user, including segment data, and may further be retrieved from a user database or another source.

Once the bid request(s) are formed, the bid request(s) are transmitted to the eligible entities at block 508. Some embodiments use a bid gateway to generate and/or transmit the bid requests. In some embodiments, traffic management and/or rate limiting is further implemented. For example, bid requests are preferably dropped that are intended for destinations (e.g., integrator networks) having expired leases, and/or that exceed a user setting for queries within a time period (e.g., queries per second).

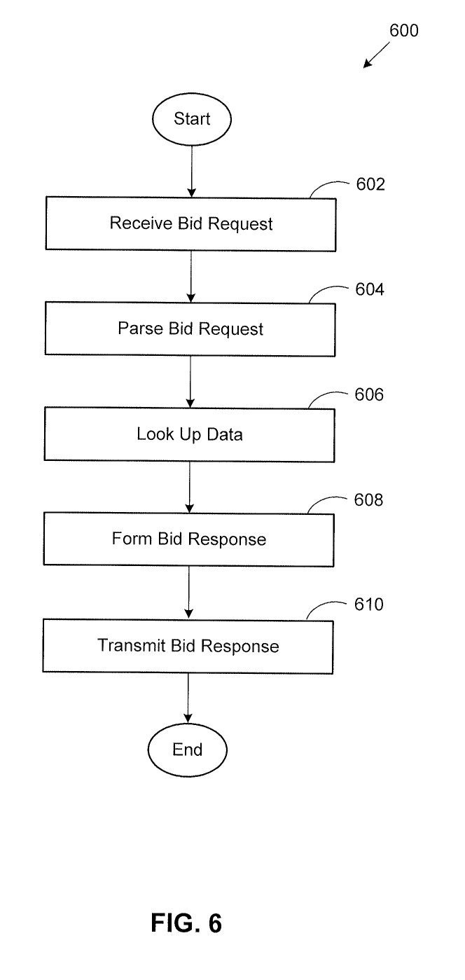

FIG. 6 is a flow diagram illustrating a process for generating a bid response in accordance with some embodiments. As shown in FIG. 6, the process 600 begins when a bid request is received at an integrator network or third-party agent at block 602. In some embodiments, the bid request is transmitted to an integrator network from a bid gateway located, for example, within a collocation facility. In some embodiments, the bid request includes various data regarding a publisher, inventory, a user, and/or a browser that are relevant to the placement of advertising. The bid request is parsed for the relevant information at block 604. The information is parsed from the bid request to look up data that the recipient of the bid request may have available, such as data for targeting of the inventory, the user, and/or the browser at block 606. The data may be available to an integrator network via its own internal storages and/or one or more third-parties or integrated entities.

The third-party agent or integrator network forms a bid response at block 608. The bid response may include a selected advertisement and/or creative, and a selected bid for the placement of the ad with the publisher, inventory, user, and/or the browser. In some embodiments, the third-party agent or integrator network makes the selection based on the information sent from the advertising exchange. Further, some bid responses may include additional useful information, such as accounting data, targeting information (e.g., behavioral-type targeting information), and/or a mapping call and information to select a creative. Once the bid request is formed, the bid response is transmitted back to the advertising exchange at block 610. The bid response is transmitted by one or more eligible entities (e.g., integrator networks) to a bid gateway for selection of a winning bid and/or advertisement. For example, an integrator network may transmit a bid response on behalf of one or more third-parties or integrated entities.

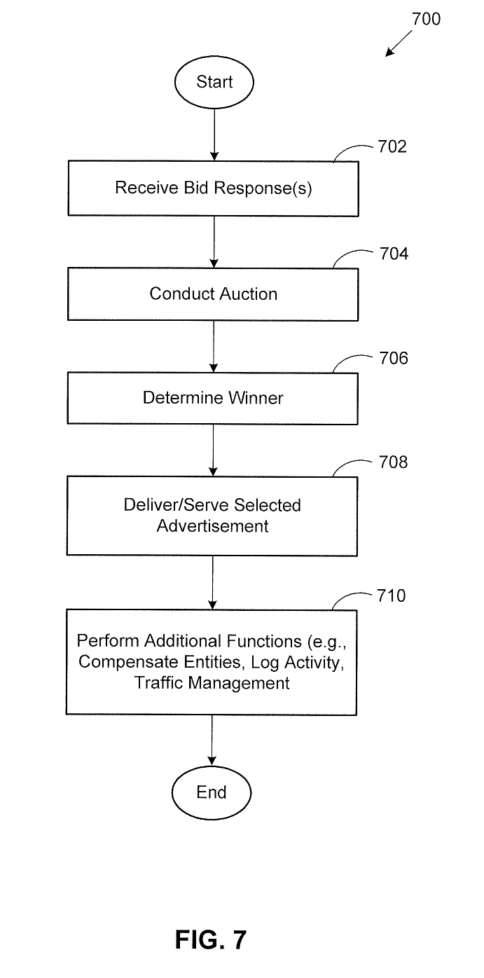

FIG. 7 is a flow diagram illustrating a process for selecting a bid and/or advertisement. As shown in FIG. 7, the process begins when one or more bid responses are received at the advertising exchange at block 702. In some embodiments, bid responses are received from an integrator network by a bid gateway. In these embodiments, the bid responses are preferably received within a predetermined amount of time. Bid responses arriving outside of the predetermined time window are generally not considered. Then, an auction for the advertising opportunity is conducted at block 704. Some embodiments may perform checks and/or validation of the bid response. In some embodiments, a bid response includes one or more of a monetary bid amount, an associated advertisement or creative, accounting information, statistical data, targeting (e.g., behavioral targeting) information, and/or a mapping call. Some bid responses may be excluded and not considered for various reasons such as invalidity, incompleteness, lateness, and/or irrelevance. A winner is determined from selected (valid) bid responses at block 706. The winner may be the highest bid, however, other criteria may be used, such as relevance and/or combinations thereof, for example.

After a winning bid and advertisement are determined, the selected advertisement is optionally delivered, served, or displayed to the user at block 708. Serving the advertisement typically involves placing the advertisement with an inventory location of a publisher for presentation to a user of a browser who is visiting the publisher's Web page having the inventory, for instance. Furthermore, additional operations or functions may be performed, such as compensation of the appropriate entities, logging activity, traffic management, and the like, at block 710.

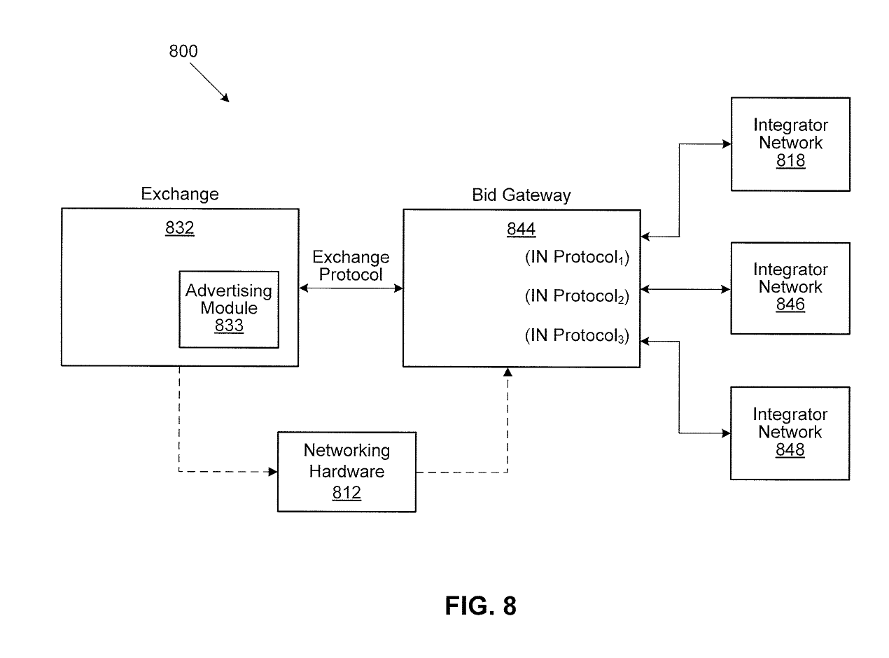

FIG. 8 is a block diagram illustrating one embodiment for implementing a bid gateway in an online advertising system 800. For this embodiment, the online advertising system includes an advertising exchange 832 having an advertising module 833 that is coupled with a bid gateway 844. Furthermore, networking hardware 812 may also be coupled with the advertising exchange 832 and the bid gateway 844 to facilitate communication therebetween with additional switching hardware. In turn, the bid gateway 844 couples third-party recipients with the online advertising system, such as with integrator networks 818, 846, 848. As shown in FIG. 8, the advertising exchange module 833 communicates with the bid gateway 844 via an exchange protocol. Preferably, the exchange protocol is a highly-efficient protocol tailored to the specific messaging format of the advertising exchange module and the bid gateway. The bid gateway 844 communicates with third-party recipients (e.g., integrator networks 818, 846, 848) using various network protocols. For the example in FIG. 8, the bid gateway 844 communicates with integrator network 818 via “Protocol₁,” communicates with integrator network 846 via “Protocol₂,” and communicates with integrator network 848 via “Protocol₃.”

By implementing an architecture of the online advertising system that includes a bid gateway, the network protocols of the auction engine (e.g., advertising exchange module) are independent of network protocols used to transmit bid requests and bids between the third-party recipients and the bid gateway. In addition, the bid gateway architecture insulates the location information of third-party recipients from the advertising exchange module.

In some embodiments, the input to the bid gateway includes a message that identifies an opportunity and the third-party entities eligible to bid on the opportunity. This message is expressed in the language of the exchange protocol. In response to the message, the bid gateway 844 stores the opportunity ID and information regarding the eligible entities. In some embodiments, the bid gateway 844 stores this data in shared memory for access by multi-processors, as described below. The bid gateway 844 configures a bid request message, and transmits the bid request message to the third-party entity using the protocol of the third-party entity.

The bid gateway architecture further allows for customization of communications, including information and the protocols between the online advertising system and third-party entities. For example, a third-party recipient (e.g., integrator network) may desire to receive certain marketing or targeting information with the bid request, while another third-party recipient may desire to receive different marketing or targeting information, or receive no targeting information with the bid request. The bid gateway architecture permits the online advertising system to scale in size. Specifically, the server architecture for the advertising exchange module 833 may be expanded independent of the cluster of servers used to implement the bid gateway 844.

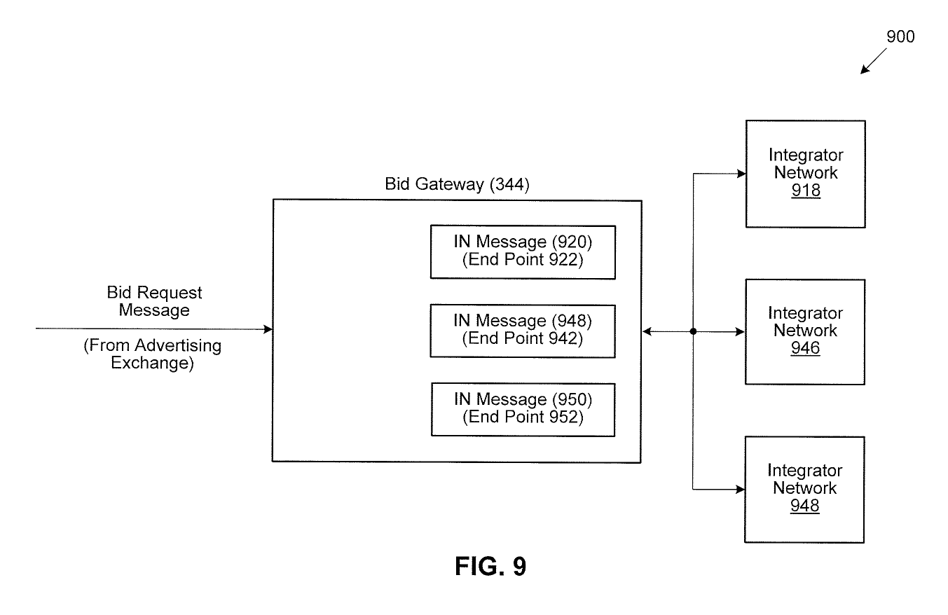

FIG. 9 is a block diagram 900 illustrating some information stored and used by the bid gateway. As shown in FIG. 9, the bid gateway 944 receives a bid request message from the advertising exchange module. The bid gateway 944 stores a message format and an endpoint location for each third-party recipient. For example, the bid gateway 944 stores message format 920 and endpoint 922 for integrator network 918, message format 948 and endpoint 942 for integrator network 946, and message 950 and endpoint 952 for integrator network 948. Using this configuration, each third-party entity may customize a message suitable for that entity. In some embodiments, a traffic manager user interface permits a third-party entity to set the endpoint, such as a URL address, for message transmission. For these embodiments, a process runs on the bid gateway to read data from the traffic manager user interface and to update the third-party information at the bid gateway.

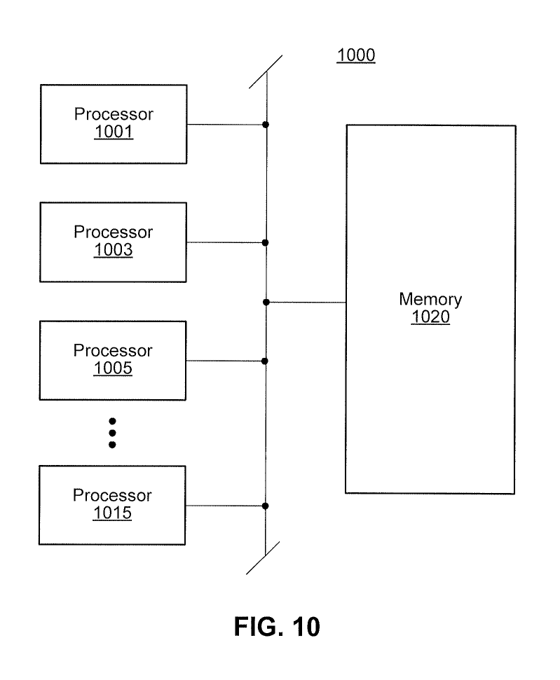

FIG. 10 is a block diagram illustrating a computer architecture 1000 for the bid gateway in accordance with some embodiments. For these embodiments, the bid gateway operates on one or more multi-processor servers. The multiprocessor architecture permits efficient execution of bid requests and bid responses. As shown in FIG. 10, the exemplary server includes processors 1001, 1003, 1005, and 1015. As illustrated in FIG. 10, the bid gateway is implemented with any number of processors. Also as shown in FIG. 10, the processors have access to shared memory 1020. In some embodiments, each processor conducts operations for a single third-party recipient. As such, when processing bid requests for an opportunity for a third-party recipient, the operation for each third-party recipient is conducted in parallel using the multi-processor architecture. The information, used to configure messages to the third-party recipients as well as transmit the messages to third-party recipients, is stored in the shared memory 1020, such as system memory.

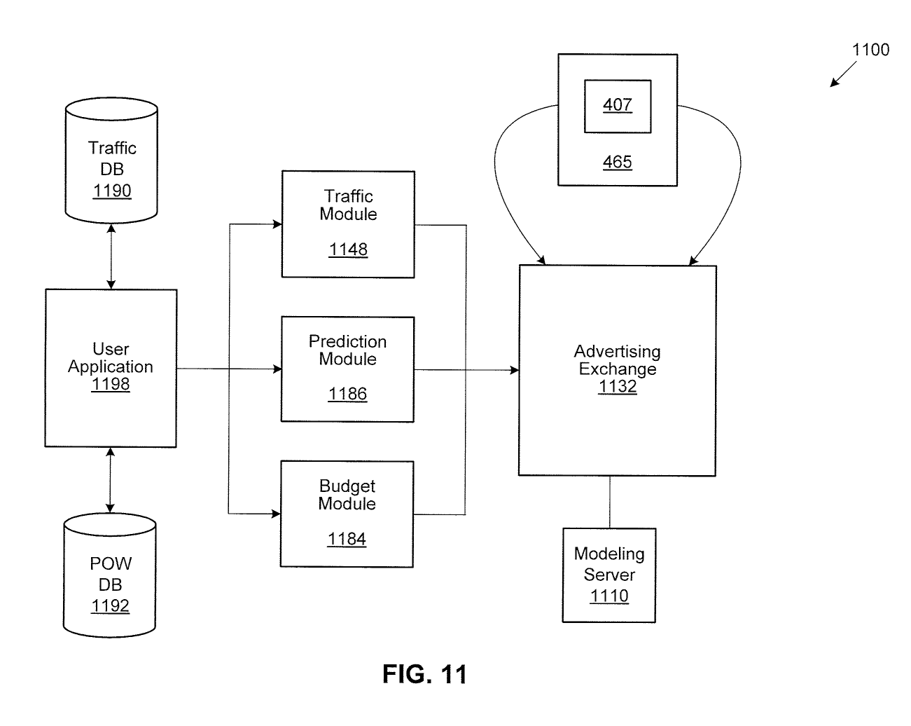

Some embodiments of the advertising delivery system include additional advantageous components. FIG. 11 illustrates an exchange system 1100 of some embodiments in further detail. As shown in FIG. 11, some embodiments further include additional modules coupled with the advertising exchange 1132, such as a traffic module 1148, a prediction module 1186, and a budget module 1184. In some cases, these modules are implemented as databases and/or data storages. The budget module 1184 contains information about how much entities on the exchange have and/or wish to spend, or their budget for various activities on the exchange, such as for the placement of their advertisements. The traffic module 1148 has information regarding historical traffic patterns on the exchange, and the prediction module 1186 provides information regarding the probable future patterns on the exchange such as, for example, where impressions are likely to be served, where clicks are likely to occur, where certain user segments may have activities, where certain targeting is likely to produce results, and the like.

The advertising exchange 1132 and additional components and modules preferably are accessible by using one or more customer and/or application interfaces. FIG. 11 further illustrates a user application 1198. In general, the user application 1198 permits a user of the advertising exchange to interface with the advertising exchange. For example, through the user application 1198, a user may access the budget module 1184, the prediction module 1186, and/or the traffic module 1148. The customer and/or network access of the user application 1198 generally includes one or more user interfaces, including graphical user interfaces, Web services including enterprise services, separated value, and/or batch access. In some embodiments, the user applications may be similar to those provided on the Advertising Publishers Exchange (APEX) or the Right Media Exchange. The user application 1198 may use its own data storage such as a traffic database 1190 and an operation warehouse (POW) 1192, respectively, for accessing and/or interacting with the components of the advertising exchange 1132.

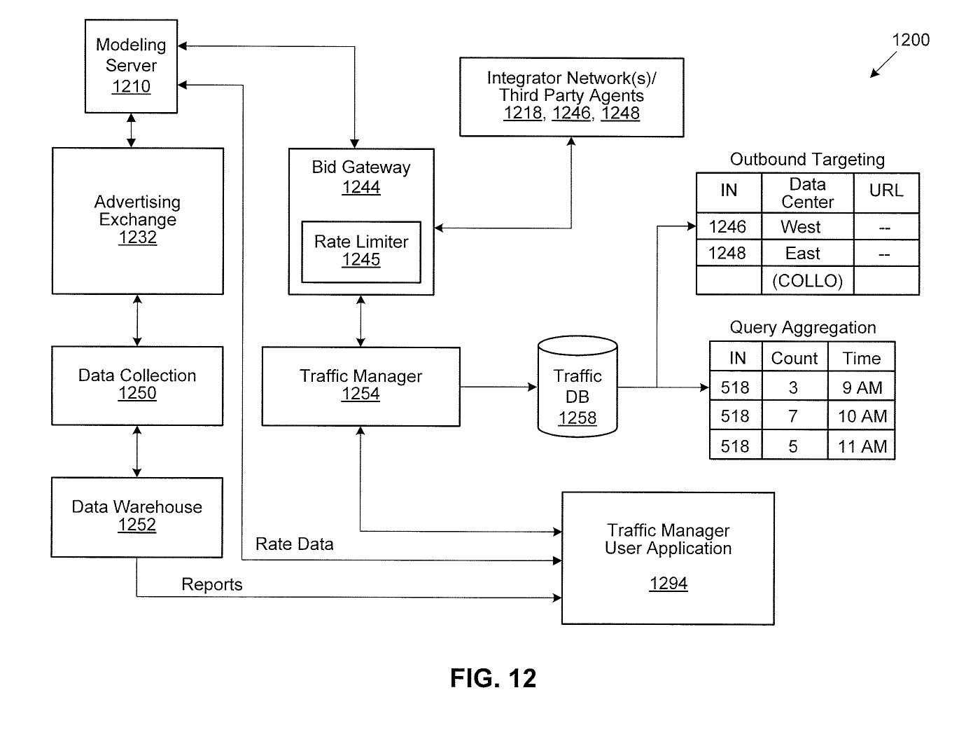

FIG. 12 illustrates another embodiment of an advertising exchange system 1200 with additional features. For this embodiment, the advertising system 1200 includes a data collection 1250, coupled with the advertising exchange 1232, a traffic manager 1254, coupled with the bid gateway 1244, and a data warehouse 1252, coupling the data collection 1250 with the traffic manager 1254. These components are advantageously used to track and control the activities on the advertising exchange 1232 such as, for example, tracking the number and activities of the eligible integrator networks or third-party agents, tracking the number of bid requests that are sent, setting the rate at which bid requests are delivered to each entity, and setting the amount of leased time each entity or agent has for receiving bid requests. These components and features are further described below.

Separately, or in conjunction with these applications, a traffic manager (TM) user application 1294 provides users (e.g., integrator networks and third-party agents) a user interface application to permit them to set functionality and acquire information from the traffic manager 1254. For example, in some embodiments, the traffic manager user application 1294 permits users to set a desired rate to receive bid requests, to generate reports regarding the number of bid requests sent, received, and timed out, to set a lease period for which the user desires to receive bid requests from the advertising exchange, and to set an endpoint location (e.g., URL) that specifies a location to send bid requests.

In some embodiment, customers or users of the applications and the exchange system, such as network-type entities, integrator networks, and third-party agents, may log into and access selected applications and interfaces to perform various administrative tasks such as choosing options, configurations, and/or settings. The customers may also retrieve information regarding activities on the exchange, such as accounting, statistics, targeting, query aggregation, and other information. For example, the traffic manager user application 1294 provides one or more of rate limiting, querying of accounting or statistics, and/or outbound targeting functions. The modeling server 1210 may also be coupled with the traffic manager user application 1294, either through the bid gateway 1244, or directly, to obtain and use traffic-related information that informs of queries per second (QPS) rates throughout the system 1200. This information aids the modeling server 1210 to track use and costs associated with that use by entities and users of the system 1200.

Preferably, the integrator networks 1218, 1246, 1248 include a variety of different types and sizes of entities. For instance, these entities may include large, sophisticated network operators, and further include smaller, niche-type players such as a mom-and-pop- type operation or a researcher in a research institution. Preferably, the system 1200 scales to the needs of each entity, accordingly. In one example, the customer entities are provided client-managed throughput and/or traffic manager features.

As shown in FIG. 12, the bid gateway 1244 includes a rate limiter 1245. The rate limiter 1245 controls the rate of transmission and/or delivery of bid requests to each eligible entity coupled with the bid gateway 1244. The traffic manager 1254 sets the user-requested bid rate in the rate limiter 1245 based on the rate set by the user from the traffic manager user application 1294.

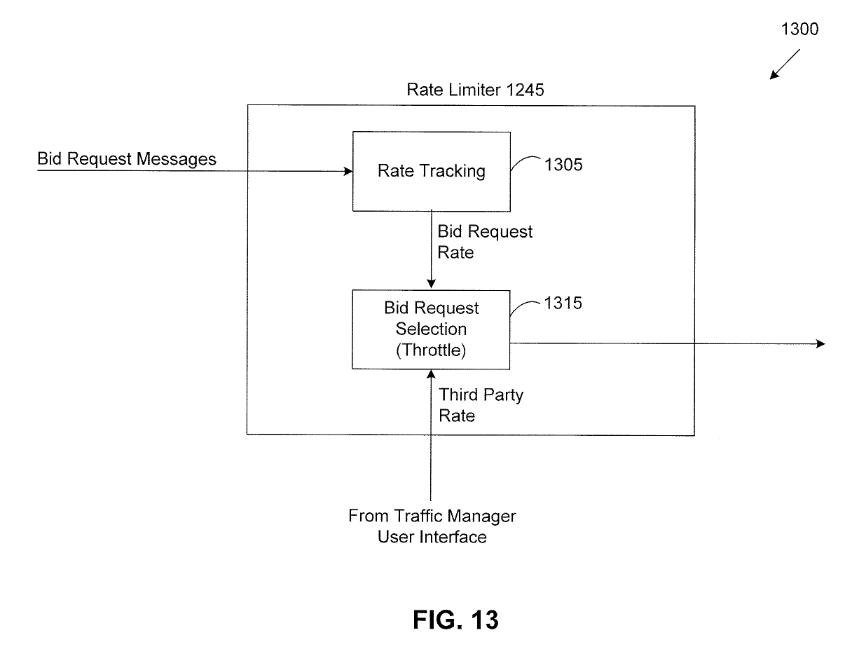

FIG. 13 is a block diagram illustrating a rate limiter 1245 for bid requests in accordance with some embodiments. For this embodiment, rate limiter 1245 includes rate tracking 1305 and bid request selection (e.g., throttle) 1315. In general, rate-tracking 1305 determines the rate at which bid requests are generated by the advertising exchange module for a particular third-party recipient. Using as inputs a historical bid request rate and a desired bid request rate set, the third-party user bid request selection 1315 matches these input parameters and selects bid requests for transmission to third-party recipients.

The rate limiter operates in a system that transmits bid requests to third-party recipients on a per opportunity basis. It is not essential that the third-party recipients receive a bid request for each opportunity. Thus, opportunities may be dropped. The rate limiter operates in accordance with these assumptions and principles.

In one embodiment, the rate limiter 1245 is time-based, as opposed to quantity- based. For example, if a selection system is purely quantity-based, then the output may select the maximum quantity desired in a very short period of time (e.g., 1000 bid requests may be dispensed in just a few minutes when the third-party recipient requests 1000 bid requests per hour). Instead, in a time-based system, the bid request selection module 1315 spreads out the transmission of bid requests to third-party recipients over time.

The rate tracking 1305 measures the rate or speed at which bid requests are received at the bid gateway for each third-party recipient. In some embodiments, rate tracking 1305 uses a histogram to track the number of bid requests for a third-party recipient. For example, in some embodiments, rate tracking 1305 sets-up a “bin,” and tracks the number of bid requests by counting the bid requests in the bin over a specified period of time. In other embodiments, rate tracking 1305 measures the time required to receive a predetermined number of bid request messages for a third-party recipient. Under this approach, rate-tracking 1305 varies the size of a time window, but maintains an equal number of bid requests within the time window. Any rate-tracking scheme that provides historical data, such as a histogram, may be used without deviating from the spirit or scope of the disclosure.

Bid request selection 1315 selects bid request messages for transfer to the third-party recipients. For example, if the third-party recipient has set the desired rate to 10 queries per second (QPS), and the rate tracking indicates a historical pattern of 100 bid requests per second (QPS), then bid request selection 1315 selects one out of every 10 bid request messages to transmit to the third-party recipient. In some embodiments, the bid request selection 1315 uses a probabilistic filter. For these embodiments, the bid request selection 1315 in essence flips a coin to determine whether to send the bid requests based on the historical rate and the desired rate set by the third-party recipient. In some embodiments, the probabilistic filter is averaged over a time window. If the time window is set relatively large, then the third-party recipient may potentially get bid requests that are not evenly spread over the time window. Alternatively, if the time window for the probabilistic filter is set too small, then too many computational resources may be required. In some embodiments, the probabilistic filter may set a time window between 5 and 15 minutes. One advantage in using a probabilistic filter is that it allows distributed control, but still provides a predictable system operation. As such, the bid gateway may be implemented over several servers, but the aggregate behavior of the entire system is predictable, which prediction can be used to forecast costs and the need to replace servers and hardware as discussed above.

In some embodiments, the traffic manager implements reporting functions. In general, the reporting functions provide a record or log of network transactions between the online advertising system (e.g., bid gateway) and the third-party recipients (e.g., integrator networks). In some embodiments, the reporting data or log records 1) errors in transmissions, 2) timeouts of bid requests to third-party recipients, 3) successful queries (bid requests sent to third-party recipients who responded with a bid in the requisite time), 4) the time of the transmissions, and 5) the location of the facility that conducted the transactions. The traffic manager may record other network transactions between the online advertising system and third-party recipients without deviating from the spirit or scope of the invention.

During operation of the system 1200, the data collection 1250 provides information regarding the type and volume of activities on the exchange, such as by the advertising exchange 1232 and/or of the system 1200 as a whole. This data may be further collected or aggregated in a data warehouse 1252, which is coupled with, and provides data to, the traffic manager 1254 and the traffic manager user application 1294. Rate data may also be supplied to the modeling server 1210 by way of the traffic manager user application 1294 or directly through the advertising exchange 1232. For example, a user of the system may generate reports regarding activity, such as bid requests and bid responses, through data collected in data collection 1250 into the data warehouse 1252 and accessed through traffic manager user application 1294. In the traffic manager 1254, the data is further available for access and/or use by applications and/or modules coupled thereto (e.g., by the traffic manager user application 1294, the bid gateway 1244, the traffic manager database 1258, and the like).

As shown in FIG. 12, the outbound targeting information may include the data center (e.g., collocation facility) of the bid request, and/or the URL of the destination for the ad of a selected bid response. For example, the outbound target destination may include the west coast, the east coast, Los Angeles, or San Francisco, as examples.

Another type of information that is used, in addition to the outbound targeting information, is query aggregation type information. As shown in FIG. 12, the query aggregation information, for this example, includes a count of the number of transmitted bid requests per entity. For this example, the system 1200 has transmitted to the integrator network(s)/third-party agents 1218, three bid requests up to the hour of 9 AM, seven bid requests from 9 AM to 10 AM, and five bid requests from 10 AM to 11 AM. The information, however, may be formatted in various ways other than the illustrated log format, and may include alternative information, such as a number of bid responses by the entity, a number of successful bids by the entity, a number of placed advertisements, the bid price or placement cost for the placed advertisements, and/or the accounting of the payout for each placement.

In some embodiments, the traffic manager 1254 may be implemented on an application server, separate from server(s) that implement the bid gateway. The traffic manager may use data storage, such as a traffic manager database 1258. In a particular implementation, the traffic manager database 1258 provides for the storage and retrieval of query aggregation information, rate limit preferences of users (e.g., integrator networks), outbound targeting information, and the like.

As discussed above, a customer may access a traffic manager user application 1294 to configure a variety of preferences for the exchange, and/or obtain a variety of information regarding activities on the exchange. More specifically, an integrator network (e.g., integrator network 1218) advantageously selects rate-limiting preferences for the transmission of bid requests transmitted from the bid gateway 1244 to the integrator network or third-party agent 1218. A large entity that is capable of high data rates and/or fast response times may prefer higher volumes of bid requests than a smaller entity. For example, a large entity may request a data rate of bid requests of 100K queries per second (QPS) versus a small entity that may request a data rate of bid requests of only 10 QPS. This improves performance both for the customer, who sets its own query/request rate and therefore is not inundated by undesirable requests, and further improves performance across the exchange. First, the exchange expends fewer resources in sending high volumes of queries to smaller entities that are likely to be quickly saturated and unavailable to respond to a majority of the volume of requests. Second, the exchange wastes less time waiting for responses to a volume of requests that has a small chance of meeting the short response time constraint, or to which the entity has no intention of responding. Using this configuration, undesired processing and/or transmission are truncated at an early stage.

At various times, entities and/or connections may become unavailable on the exchange system. For example, an integrator network 1218 may be unable to receive or respond to queries (e.g., bid requests) and further may be unable to inform the exchange system or bid gateway 1244 of its status, or to even interact in other ways such as set its rate preferences. Some embodiments have a leasing time setting for each eligible entity, and some entities are further able to set their own leasing times. For example, the integrator network 1218 may set a leasing time of five minutes, and further sets a maximum bid request throughput of 100K queries per second (QPS). As an example, the advertising exchange 1232 may receive a massive number of ad queries, and may determine that the integrator network 1218 is eligible for those ad queries. The bid gateway 1244 and traffic manager 1254 (e.g., by using a rate limiter 1245) may further determine whether the number of queries sent to the integrator network 1218 is less than the threshold preference set by the integrator network 1218 (e.g., 100K QPS). The bid gateway 1244 may further determine whether the integrator network 1218 has a current valid lease (e.g., that has not expired, or that has been renewed). If each condition is met, then bid request(s) are transmitted to the integrator network 1218. If, for example, the Internet, local area, and/or collocation network connection from the bid gateway 1244 to the integrator network 1218 fails, or becomes temporarily unavailable due to congestion or another cause, or if the internal systems or servers of the integrator network 1218 are inoperable for a period longer than the leasing time, then the system 1200 advantageously foregoes transmissions (e.g., queries or bid requests), and does not wait or expect responses from the integrator network 1218.

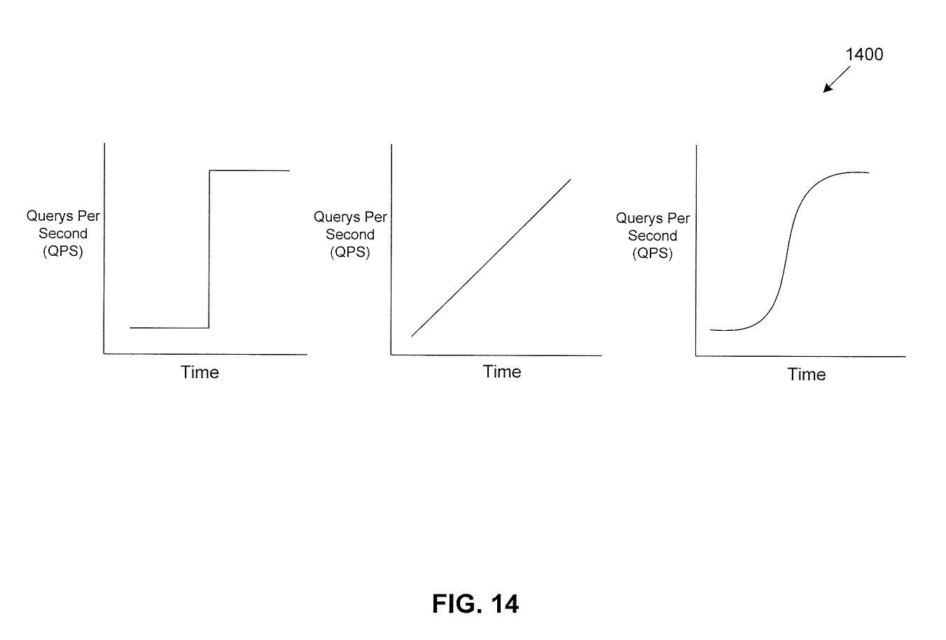

Regardless of the cause of unavailability, the integrator network 1218 advantageously resets its leasing time, rate preferences, and other configuration settings, when it so desires or is able to resume activities on the exchange system. Moreover, the integrator network 1218 may custom tailor ramping for its activities on the exchange. For example, the integrator network 1218 may set a high volume of queries per second over a long continuous leasing time for sharp ramp up to near capacity for receiving bid requests. Alternatively, the integrator network 1218 may set incrementally increasing volumes of queries per second over several shorter leasing times for a gradual or sloped ramping of bid requests and activities on the exchange. Some ramping profiles are illustrated in FIG. 14.

In some embodiments, during operation of the system 1200, historical and/or pattern data are accumulated at various locations including, for example, the traffic manager database 1258. For example, the data may include the settings of participating entities, rate preferences, leasing times, and also other information derived from the various components of the exchange system, such as the advertising exchange 1232, data collection 1250, data warehouse 1252, traffic manager 1254, and/or bid gateway 1244. The data may further include outbound targeting data, query aggregation data, and other accounting and statistical information. Customers, such as integrator networks, preferably access the stored information for verification with their own records of bid requests, responses, and/or placed advertisements. Such verification is particularly useful in pay-to-play type models where the entity pays for each of a type of transaction on the exchange (e.g., pays based on number of bid requests transmitted, and/or based on number of bid responses, and not only based on winning bids or placed advertisements).

U.S. patent application Ser. Nos. 12/398,841 and 12/398,877, both filed Mar. 5, 2009, which were referred to above, discuss transferring, targeting, and marketing information in bid requests to third parties. These applications, owned by the assignee of the present application, are incorporated herein by reference. Accordingly, the details of these applications will not be repeated here, which discuss, in part, how marketing and targeting information may be passed through the bid request or be obtained through a proprietary system of an advertiser that uses the bid request to obtain such information. The processing involved with extracting and integrating marketing and targeting information into the bid response process by an advertiser is part of the latency that may occur in the exchange server or bid gateway server receiving bids and corresponding advertisements in response to requests for bids. These latencies may be tracked over time and also predicted based on historical data by methods the same or similar to those discussed above; the latencies may then become part of the bandwidth cost analysis that is discussed in more detail below.

The foregoing embodiments advantageously use (bid request) rate control, time outs, and the like, to advantageously provide high-speed integrated and/or federated exchange services without the need for other optimizations, additional facilities, or components. The additional features described next are advantageously used alternatively, or in conjunction with, the foregoing embodiments.

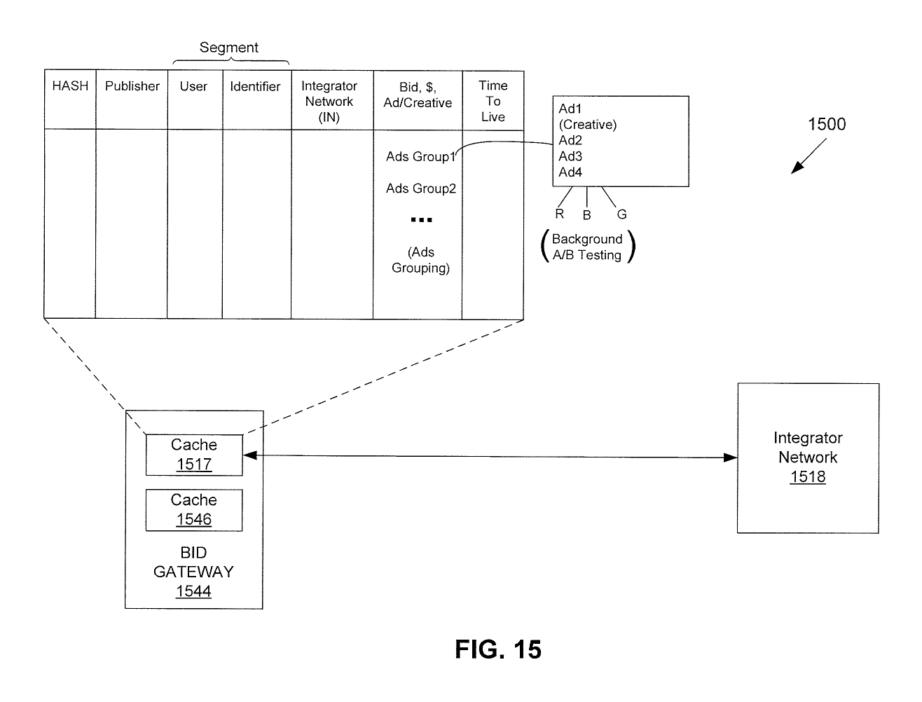

FIG. 15 illustrates an advertising bid system that implements server-side caching. As shown in FIG. 15, bid information, corresponding to integrator networks or third-party agents, is advantageously cached at the advertising exchange. Under such a configuration, repeat bid requests and/or bid responses are generated and/or transmitted faster. In the embodiment of FIG. 15, the caching occurs at bid gateway 1544. However, in other embodiments, all or part of the caching may be stored by using other portions of the system 1500, such as integrator networks (e.g., 1518), servers for the advertising exchange, or a collocation site and/or facility, by way of example.

In some embodiments, the bid gateway 1544 is preferably coupled with each integrator network (e.g., 1518), such that caches 1517 and 1546 may be updated with the most recent and/or relevant data for the cache entries (e.g., bid information).

In some embodiments, the caching includes a rapid data retrieval format, including a lookup and/or hash table format. Such an exemplary format is illustrated in a cache 1517 of FIG. 15. The exemplary table of this embodiment includes several columns, including a hash and/or lookup value column, and columns for one or more of publisher identifiers, user identifiers including user segments, integrator network (IN) identifiers, bids for ads (e.g., creatives), and/or a time to live (TTL) column. Some embodiments group the ads and/or ad creatives by bid amount, background (R, B, G), and/or by A/B testing. Hence, some embodiments select an advertisement from a group of ads for a particular cache line/entry (e.g., randomly, or by using another method), when the cache line is selected in a high-speed response to a bid request.

The hash and/or lookup value provides a fast pattern matching system for one or more repeat occurrences of some or all of an ad query, bid request, and bid response cycle. For example, each hash and/or lookup entry in the table preferably allows for rapid matching of the content and/or inventory of a publisher to selected users, segments, integrator networks, bids, ads, and/or creatives. In some embodiments, each cache line entry expires within an optimal time period thereby minimizing unnecessary storage of stale cache entries. The time-to-live sets the time period before the cache line entry is deleted from the cache.

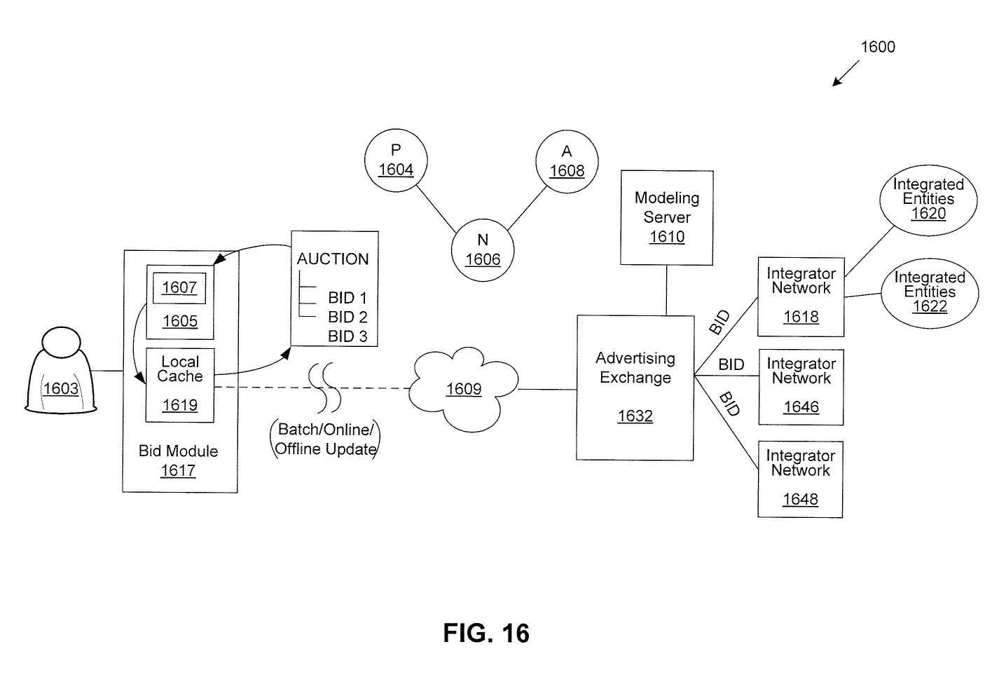

FIG. 16 illustrates a bid per opportunity advertising system that includes client and/or browser side (local) caching. As shown in FIG. 16, the system 1600 includes a user 1603 who interacts with a browser 1605. For this embodiment, the browser 1605 implements one or more auction functions on the user's machine. More specifically, the browser 1605 is coupled with various networks 1606, and one or more advertising exchanges 1632 through wide area network 1609. The network 1606 may have one or more associated entities, such as publishers 1604 and/or advertisers 1608. The system 1600 may also include integrator networks 1618, 1646, and 1648 that have integrated entities 1620 and 1622.

At various times, advertising is requested for inventory locations 1607 within the browser 1605. In some embodiments, the advertising and/or bid requests to entities of the exchange are delivered to a bid module 1617 with a local cache 1619. The bid module 1617 and local cache 1619 are associated with the browser 1605 and/or inventory 1607 that is the destination for the requested advertising. For example, bid module 1617, associated with browser 1605 and/or inventory 1607, may receive one or more bids from various sources of advertising on the exchange. In response, bid module 1617 may conduct an auction offline, online, and/or in real time to determine the winner of the auction for placement of advertising with the inventory 1607. Furthermore, the bid module 1617 may place the winning advertisement within the inventory 1607 for presentation to user 1603. In some embodiments, the bid module 1617 may further provide accounting and/or logging information. The accounting or logging information may be later used for compensation of entities as well as for overall record keeping for the entities on the exchange. Some embodiments may further provide for user segmenting and/or mapping of user information for entities on the exchange including third-party entities.

In some embodiments, the local cache 1619 may include the contents and may be implemented similar to the cache 1607, described above in relation to FIG. 16. However, in the embodiments of FIG. 16, the cache is local to the machine of the user 1603. Accordingly, for local caching embodiments, necessary data are loaded and/or updated in an offline or batch process, and at least some or all of the ad/bid call, request, response, auction, and/or inventory placement process is performed locally at the user's local machine. Some embodiments use a scripting language (e.g., JAVA) for the bid module 1617, in conjunction with the local cache 1619 and browser, to implement the foregoing local bid, auction, and/or placement process.

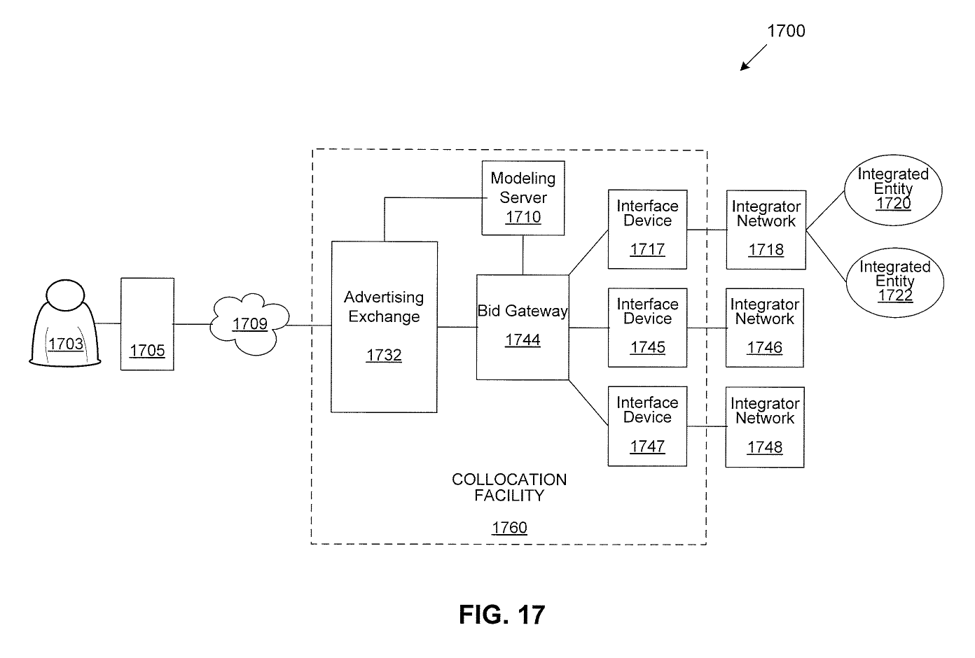

FIG. 17 illustrates an advertising system for collocation of integrator network devices within a collocation facility, such as a data center. As shown in FIG. 17, a user 1703 and browser 1705 are coupled with a collocation facility 1760 through a network 1709. The network 1709 may include a variety of networks, such as, for example, a local area network (LAN), a wide area network (WAN), a network of networks, the Internet, and other networks. One or more integrator networks 1718, 1746, 1748, and/or integrated entities 1720, and/or 1722, are coupled with the collocation facility 1760 either through the network 1709, and/or through a plurality of interface devices 1717, 1745, 1747 within the collocation facility 1760.

The interface devices 1717, 1745, 1747 may advantageously be dedicated to the integrator networks 1718, 1746, and 1748, respectively. The devices 1717, 1745, 1747 permit high data rate transmission between the bid gateway and the integrator network devices, and/or third-party devices, (e.g., third-party bid agent equipment). High data rate transmissions include, for example, fiber optic and similar channels, gigabit Ethernet, various forms of SCSI, micro channel, and the like. The devices 1717, 1745, 1747 may include all or part of the bid receipt and/or response architecture for one or more of the integrator networks 1718, 1746, 1748, and/or their integrated entities 1720 and 1722. Further, the devices 1717, 1745, 1747, may include caching structures such as described above within the devices, the bid gateway, and/or the advertising exchange within the collocation facility 1760 to further enhance the speed of operation.

The collocation facility 1760 may include, within a single site, various components for the rapid operation of a bid request/response system including, for example, one or more advertising exchanges 1732, one or more bid gateways 1744, and various integrator network and/or third-party interface devices 1717, 1745, 1747. Several collocation facilities 1760 are preferably located and operated from within multiple predetermined geographic regions. For instance, multiple and/or redundant collocation facilities 1760 are located within multiple locations across the Internet, such as San Francisco, Los Angeles, and New York, to serve North America and/or the United States, while additional facilities may be placed in local geographic regions to serve particular continents such as Europe, Asia, Africa, South America, and/or cities therein, as examples.

The online advertising exchange may participate in fulfilling both guaranteed and non-guaranteed contracts to the integrator networks 1718, 1746, 1748 and/or to the integrated entities 1720, 1722 and/or to other publishers, depending on what contracts are developed therebetween. For these embodiments, when conducting an auction, the online advertising exchange does not differentiate between inventory that may be sold to fulfill a guaranteed contract, and inventory that does not result in fulfillment of a guaranteed contract (i.e., referred to as “nonguaranteed inventory”). For these embodiments, when the advertising exchange module (e.g., FIG. 3) determines eligibility among entities, it does not execute a “routing” rule to select, as eligible entities, only those entities for which delivery of the opportunity results in fulfillment of a guaranteed contract. Instead, the advertising exchange module allows all eligible entities to bid on the opportunity, and it does not distinguish between guaranteed inventory and nonguaranteed inventory. Furthermore, the online advertising exchange system provides an accounting to track transactions among a buyer, seller, and one or more intermediaries. An intermediary, as an example, may be an integrator network that fulfills transactions according to contract.

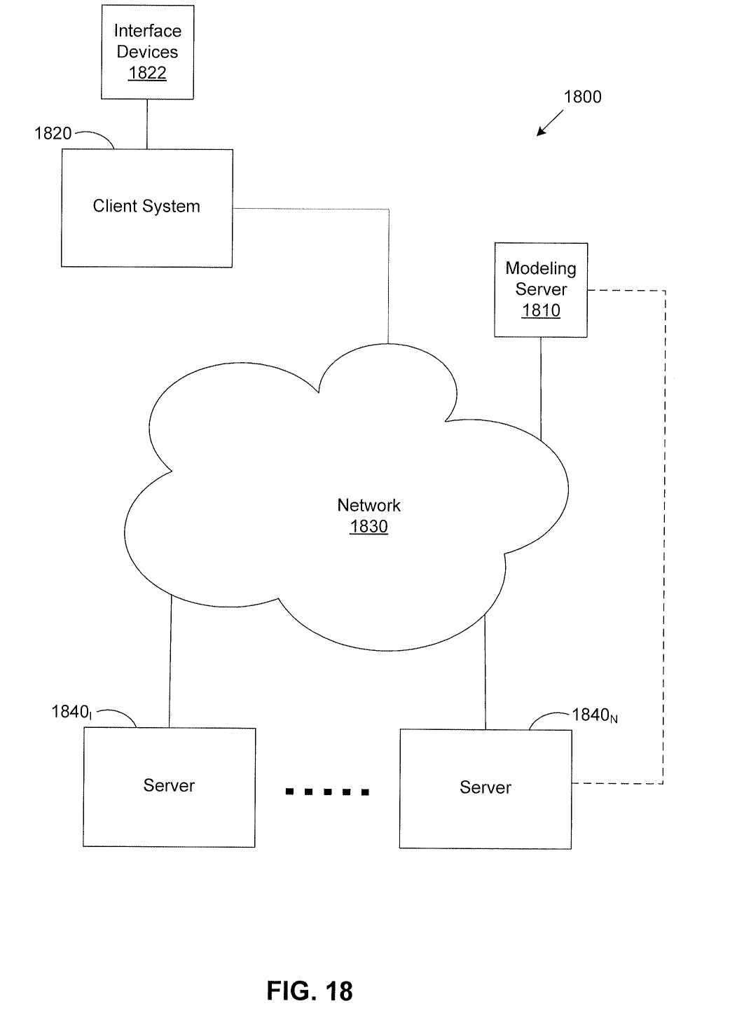

FIG. 18 illustrates one embodiment of a network environment 1800 for operation of the online advertisement system of the present invention. The network environment 1800 includes a client system 1820 coupled to a network 1830 (such as the Internet, an intranet, an extranet, a virtual private network, a non-TCP/IP based network, any LAN or WAN, or the like, and server systems 1840₁ to 1840_{N}. The client system 1820 is configured to communicate with any of server systems 1840₁ to 1840_{N}, for example, to request and receive base content and additional content (e.g., in the form of a Web page).

A server system, as defined herein, may include a single server computer or a plurality of server computers. The servers may be located at a single (collocation) facility or the servers may be located at multiple facilities. In some embodiments, the advertising exchange module includes a plurality of servers, such as server systems 1840₁ to 1840_{N}. The bid gateway includes one or more additional servers, coupled to and accessible by the server systems for the advertising exchange module, such as server systems 1840₁ to 1840_{N}. In addition, the third-parties to the online advertising exchange system, such as integrator networks, third-party agents and third-party recipients, include one or more servers, such as servers 1840₁ to 1840_{N}. As such, servers 1840₁ to 1840_{N} are intended to represent a broad class of server farm architectures and may be configured in any manner without deviating from the spirit or scope of the present disclosure.

The client system 1820 may include a desktop personal computer, workstation, laptop, PDA, cell phone, any wireless application protocol (WAP) enabled device, or any other device capable of communicating directly or indirectly to a network. The client system 1820 typically runs a Web browsing program that allows a user of the client system 1820 to request and receive content from the server systems 1840₁ to 1840_{N} over the network 1830. The client system 1820 typically includes one or more user interface devices 1822 (such as a keyboard, a mouse, a roller ball, a touch screen, a pen, or the like) for interacting with a graphical user interface (GUI) of the Web browser on a display (e.g., monitor screen, LCD display, etc.). A modeling server 1810 may be coupled with any or all of the server systems 1840₁ to 1840_{N} locally or over the network 1830.

In some embodiments, the client system 1820 and/or system servers 1840₁ to 1840_{N} are configured to perform the methods described herein. The methods of some embodiments may be implemented in software or hardware configured to optimize the selection of additional content to be displayed to a user.

The third-party integrated (3PI) architecture disclosed and described above includes a plurality of server and network costs that involve both fixed costs and operational costs, which include maintenance costs, in addition to bandwidth costs. As described above, the modeling server, or other computer, or the advertising exchange itself, may track query per second (QPS) rates at various portions and throughout the auction-based, real-time advertising system in order to predict both revenue and costs to ensure continued cost-based viability of the system. Table 1 includes a basic overview of the types of costs involved, which will be expanded on below. The advertising exchange server will also be referred to herein as an ad server for simplicity.

TABLE 1

| | FIXED COSTS | OPERATIONAL COSTS |
|---|---|---|
| SERVER | 1. Bid Gateway Box Cost | 1. Power |
| COSTS | 2. Ad Server Box Cost | 2. Cooling |
| NETWORK | 1. Switch/Router | 1. In-colo Bandwidth Costs |
| COSTS | Hardware Costs | 2. Extra-colo Bandwidth Costs |

After predicting or estimating hardware and operability (bandwidth) costs, the modeling server may generate scenarios concerning how these costs can be recovered by bid payout and tech fees. The modeling server may also track how the cost components change when the following parameters change: (1) number of third-party networks (3PN); (2) the average message size of the 3PN bid requests and responses; (3) 3PN participation rate; and (4) a 3PN participation overlap.

The following assumptions may be made to simplify the modeling performed by the modeling server: (1) one 3PN creates one entity in the exchange data model; (2) the bid request and response message sizes are assumed to be constant; and (3) there is a fixed latency budget for 3PNs to respond. With regards to number two, depending on the network model being used, an advertiser can be reachable via multiple paths from the source publisher. There could be competing integrated networks that have concurrent deals with the same third-party advertiser which create the possibility of multiple paths, for instance. Accordingly, there could be some variation in bid request and response sizes, but the model assumes that they are constant for simplicity, or as seen later, may simply average them together. The following Table 2 summarizes cost model parameters and exemplary values for those parameters, which the cost model may employ in automating its estimations and predictions, as explained below.

TABLE 2

| Name | Possible Value | Description |
|---|---|---|
| daily_adqueries | 9 billion | Number of ad queries (impressions) per day |
| number_adservers_3PI | 6,000 | Number of ad servers with 3PI enabled |
| peak_adserver_QPS | 25 | Peak QPS of ad servers |
| number_3PN | 5 | Number of 3PNs |
| 3PN_particpation | 8% | Percentage of ad queries for which one 3PN |
| | | is eligible |
| 3PN_participation_overlap | 50% | Percentage of 3PNs that participate together |
| | | when there is an ad query |
| 3PN_message_size | 2 KB | Average size of bid request and response |
| 3PN_query_ratio | 3PN_participation/ | Percentage of ad queries resulting in a 3PI |
| | 3PN_participation_overlap | callout |
| num_daily_3PN_adqueries | daily_adqueries * | Number of daily ad queries with 3PN |
| | 3PN_query_ratio | participation |
| BG_QPS_1K | 1800 | Sum of peak incoming and outgoing QPS for |
| | | bid gateway at 1 KB message size |
| BG_QPS_5K | 1500 | Sum of peak incoming and outgoing QPS for |
| | | bid gateway at 5 KB message size |

Note that if all the 3PNs are competing for the same opportunities, then the 3PN_participation is 100%. In contrast, if every 3PN targets totally different publishers, then on average each ad query will only have one 3PN associated therewith, and the 3PN_participation_overlap would be one divided by the number of 3PNs.

There are at least two kinds of costs for a server or for networking hardware, including an upfront cost corresponding to the price, and the operating costs in terms of power and cooling. According to costs of serving models, these two costs are amortized to a fixed life time of a predetermined period. The predetermined period of time is usually about 3 years (or 36 months). The total cost of ownership for a server in 3 years is 2.5 times the upfront box price of the server. The model also assumes that the switch or router depreciation is also 3 years and the total cost of ownership is again 2.5 times the original hardware cost. Below, in Table 3, is a list of costs associated with the server and network hardware described above.

TABLE 3

| Name | Value | Description |
|---|---|---|
| box_upfront_price | $1400 | Upfront price for a server |
| box_TCO_factor | 2.5 | Box total cost of ownership for 3 years is 2.5x the |
| | | base price |
| BAS_switch_price | $50,000 | Upfront price for a BAS switch |
| BAS_TCO_factor | 2.5 | BAS total cost of ownership for 3 years is 2.5x the |
| | | base price |
| box_monthly_cost | Box_upfront_price * | The amortized daily cost of a server |
| | box_TCO_factor/ | |
| | (3 * 12) | |
| BAS_monthly_cost | BAS_switch_price * | The amortized daily cost of a BAS switch/router |
| | BAS_TCO_factor/ | |
| | (3 * 12) | |
| BAS_bandwidth | 10 Gbit | The bandwidth that a BAS switch/router can |
| | | support |
| Bandwidth_price | $3.44 | Bandwidth Price per Megabyte per Month |

Note that the BAS is the main switch or router currently employed within the networking hardware of the collocation data center. One of skill in the art will recognize that different switches or routers may be used besides the BAS switch or router. Also, one of ordinary skill will recognize that values may be input into the cost model based on changing conditions or assumptions, including amortization period and total cost of ownership, etc.

The total bid gateway box costs are now described, in which the bid gateway is limited in three aspects: (1) computation that is required to serialize/deserialize data packets and the security signing of bid requests/responses; (2) bandwidth required to communicate with advertising exchanges and bid servers, e.g., with a 1 Gbit Ethernet card; and (3) a number of in-flight messages that equals the number of opened file descriptors. These limitations are reflected in the average QPS that a bid gateway can support. The term “in-flight” refers to the bid gateway real-time operation of passing and receiving bid requests and responses, respectively.

When the bid request/response message size is around 3 KB, neither the bandwidth nor the computation is the bottleneck. The in-flight number of messages affects the bid gateway performance the most. Assuming 3PNs are responding within a fixed latency, the model sums the incoming and outgoing QPS to characterize the peak performance of bid gateways. It has been observed through execution of the cost data model that when 3PN participation overlap is high, the bid gateways can support higher peak QPS.

The overlapping participation refers to the degree that 3PNs compete for the same set of opportunities, e.g., for ad queries or impressions, which arrive in the form of a bid request. The extreme cases include (A) no overlap of qualification on ad queries and (B) complete overlap, or in other words, all of the 3PNs qualify for the same ad queries. The following is a basic illustration of the impact on the bid gateway for each of these two extreme cases (no overlap and complete overlap).

As between the advertising exchange (or ad server) and the bid gateway, the bid gateway connects with ad servers using an optimized connection method possible within the data collocation facility. The communication within the collocation facility has a lower latency than communication outside of the collocation facility. Only one message is passed between the advertising exchange and the bid gateway for one ad query (impression call), no matter how many 3PNs are qualified for the opportunity. However, the more 3PNs that are participating, the larger the message size becomes.

As between the bid gateway and the information service provider (ISP) out to the 3PN bid servers, separate http connections are usually used for each 3PN. The communication that is thus outside the collocation facility has a higher latency than that within, as discussed above. The two extreme cases of participation overlap introduced above have the same outgoing QPS. Suppose the bid gateways' maximum outgoing QPS is 500. That is, within a second, there are 500 call outs to 3PNs. For the no overlap scenario (A), the 500 call outs are evenly distributed; and for the 100% overlap scenario (B), the 500 call outs are grouped into packets of 500 divided by the number of 3PNs, and the packets are evenly distributed. Because the number of 3PNs is very small compared with 500, the two traffic patterns do not imply different bandwidth requirements outside of the collocation facility. The conclusion is that the sum of incoming and outgoing QPS in case (A) is larger than that in case (B), thus the bid gateways perform better in case (B), with 100% overlap.

After measuring the bid gateway QPS at message size 1K and 5K, a linear function was used for messages sized in between those two rates. Table 4, below, displays the functions to be calculated at least on a daily basis.

TABLE 4

| Name | Value | Description |
|---|---|---|
| BG_QPS | BG_QPS_5K + (BG_QPS_1K − | Sum of peak incoming and |
| | BG_QPS_5K) * (5 − 3PN_message_size)/4 | outgoing QPS for bid |
| | | gateways |
| num_callout | daily_adqueries * participation * num_3PN | Number of 3PN call out per |
| | | day |
| num_BG | num_adserver_3PI * peak_adserver_QPS * | Number of bid gateway |
| | (3PN_participation * num_3PN + | boxes required |
| | 3PN_query_ratio)/BG_QPS | |
| BG_monthly_costs | num_BG * box_montly_cost | Monthly cost of all bid |
| | | gateways |

With the parameters and calculated values, monthly costs for a certain QPS rate given a certain number bid gateways may result in an approximate monthly cost for the bid gateways. This calculation may be subsumed within the advertising exchange (ad server) calculation if there are no bid gateways, and all bid request generation and bid response reception happens through the advertising exchange itself.

Based on a queue model designed according to Tables 1-4, the end-to-end latency is a nonlinear function of the incoming QPS. For example, the end-to-end latency may be the addition of the two following latencies: (1) 296 for a 20 QPS extra-collocation; and (2) 279 for a 19 QPS intra-collocation. With the 3PN call out, the advertising exchange will have additional latency. For users to observe the same end-to-end latency when there is a 3PN call out, the incoming QPS for those active 3PN advertising exchanges should be reduced, thus the waiting queue is shorter and the latency overhead of “calling out” to the 3PNs may be reduced. The 3PN participation overlap has a significant impact on this cost. With the same overall participation, the more the overlap—or competition for the same set of bid request—among the 3PNs, the smaller the number of advertising exchanges need to perform “calling out,” thus the less impact to overall latency. This means that the system and network hardware located within the collocation facility can support a larger bandwidth demand in terms of QPS of bid request and bid responses given the same amount of hardware; therefore, there are fewer associated costs. Table 5, shown below, displays parameters that may be used in the calculation of total costs of advertising exchange server boxes, and the cost of any additional exchange server boxes that become required.

TABLE 5

| Name | Value | Description |
|---|---|---|
| 3PN_QPS_derating | 3% | The percentage decrease in QPS for |
| | | 3PN active ad exchanges (servers) |
| active_3PN_adservers | Number_servers_3PI * | The average number of ad exchange |
| | 3PN_query_ratio | servers doing live 3PN call outs |
| num_added_adservers | Active_3PN_adservers * | The number of additional ad exchange |
| | 3PN_QPS_derating | servers to compensate for reduced QPS |
| | | due to 3PN call outs |
| adserver_monthly_costs | num_added_adservers * | Monthly cost of all additional ad |
| | box_monthly_cost | exchange server boxes |

The bid request/response size not only affects the QPS of the bid gateway, but it also determines the total bandwidth of supporting 3PN call outs. There are two bandwidth requirements for the system: (1) within the collocation facility communication with ad exchange servers; and (2) outside the collocation facility communication with 3PN bid servers. These two bandwidths are priced differently, so the model uses an average price of the two. Typically, the bid response contains the advertisement from the 3PN and is larger in size than the bid request. Message size is, therefore, the average of the two. Table 6, shown below, includes parameters that may be used to calculate total bandwidth costs.

TABLE 6

| Name | Value | Description |
|---|---|---|
| 3PN_message_bandwidth | num_BG * 3PN_message_size * | 3PN message bandwidth |
| | peak_BG_QPS | requirement |
| total_monthly_bandwidth_cost | bandwidth_price * | Total Bandwidth cost per |
| | 3PN_message_bandwidth | month |

The bandwidth price, of course, may vary and be set by the owner and operator of the exchange system, or by an ad network such as owned by Yahoo! Total networking bandwidth costs, such as for switches or routers used in the collocation facility that support communication between the ad exchange server(s) and the bid gateway server(s), may also be calculated as per the parameters in Table 7.

TABLE 7

| Name | Value | Description |
|---|---|---|
| num_BAS | Ceiling (3PN_message_bandwidth/ | Total number of BAS |
| | BAS_bandwidth) | switches or routers |
| Total_monthly_BAS_cost | BAS_monthly_cost * num_BAS | Total cost of BAS |
| | | switches or routers |

Advertising exchanges charge 3PNs monthly fees to cover their costs of operation as described above, including server box and networking hardware, in addition to bandwidth costs. The model may also average the exchange costs to the number of times 3PNs are called, or average to the number of ad queries in which the 3PNs participate. Overall costs are amortized over three years (or 36 months). Most businesses replace computer hardware about every three years, on average, as this is the effective life of the computer hardware, proving the business desires to remain efficient and as fault-free as possible. Table 8, shown below, displays parameters that may be used to determine total costs associated with the auction-based exchange system, including intra- and extra-collocation facilities, and total hardware and bandwidth costs.

TABLE 8

| Name | Value | Description |
|---|---|---|
| monthly_cost | BG_monthly_costs + | Monthly cost that the |
| | adserver_monthly_costs + | exchange needs to recoup for |
| | total_monthly_bandwidth_cost + | supporting the defined |
| | total_monthly_BAS_cost | scenario. This is total cost |
| | | (upfront + operational)/36. |
| monthly_cost_per_3PN | monthly_cost/Num_3PNs | Per 3PN cost per month that |
| | | the exchange needs to recoup |
| | | for supporting the defined |
| | | scenario, e.g., the total cost |
| | | (upfront + operational)/(36 * |
| | | Num_3PNs) |
| cost_per_3PN_callout | monthly_cost/30/num_callout | Per 3PN callout cost per |
| | | month that the exchange |
| | | needs to recoup for |
| | | supporting the defined |
| | | scenario, e.g., the total cost |
| | | (upfront + operational)/(36 * |
| | | Num_of_3PN_callouts_in_a_month) |
| cost_per_query_with_3PN_participation | monthly_cost/30/ | Per 3PN-participated query |
| | num_daily_3PN_query | cost per month that the |
| | | exchange needs to recoup for |
| | | supporting defined scenario, |
| | | e.g., total cost (upfront + |
| | | operational)/(36 * |
| | | Num_of_3P_participated_queries_in_a_month) |
| upfront_cost_per_3PN | (box_upfront_price * (num_BG + | Per 3PN upfront cost that the |
| | num_added_adservers) + | exchange needs to recoup for |
| | BAS_switch_price * num_BAS)/ | supporting the defined |
| | Num_3PNs | scenario, e.g., the upfront cost |
| | | (upfront/Num_3PNs) |
| incremental_cost_per_3PN_month | monthly_cost_per_3PN − | Per 3PN incremental cost per |
| | upfront_cost_per_3PN/36 | month that the exchange |
| | | needs to recoup for |
| | | supporting the defined |
| | | scenario, e.g., the total |
| | | operational cost (operational/ |
| | | (36 * Num_of_3PNs)) |

For example, in calculating total costs, assume that there are five 3PNs, each participating in 8% in ad query (calls), and on average there are 2.5 third-party networks (3PNs) per ad query (or call out). Based on these assumptions, the tech fee for each 3PN would be: (1) $1,900 a month; or (2) $0.09 per one million times a 3PN is called; or (3) $0.22 per one million ad queries with 3PN participation.

The per 3PN cost may be scaled to account for different cost components that respond to changes in the above parameters differently. The parameters may generally be scaled as follows. For the number of 3PNs, the scaling for: (1) the bid gateway costs is sub-linear; (2) the ad exchange server costs is sub-linear; (3) the bandwidth costs is sub-linear; and (4) the networking costs is sub-linear. For the level of 3PN participation, the scaling for: (1) the bid gateway costs is linear; (2) the ad exchange server costs is sub-linear; (2) the bandwidth costs is linear; and (4) the networking costs is step. For the level of 3PN participation overlap, the scaling for: (1) the bid gateway costs is inverse; (2) the ad exchange server costs is inverse; (3) the bandwidth costs is inverse; and (4) the networking costs is inverse.

The third-party integration (3PI) cost model disclosed above gives an estimation of the breakdown of different cost components, including server and networking hardware and associated bandwidth costs. Typical scenarios show that 3PNs need not pay expensive tech fees for the fee collection efforts of the advertising exchange to support the viability of the 3PI exchange system. The cost model also suggests that, with the addition of more 3PNs, the fee to each 3PN will decrease. Also, the participation rate is quite influential to the cost per 3PN. In the exchange data model, the entities and targeting constraints for 3PNs should be carefully considered so that a 3PN is called only when it has a high—or at least above-average—chance of winning the auction. Furthermore, the overlapping participation among 3PNs has a large impact on the cost per 3PI ad query. The higher the overlapping, the higher the per ad query cost overall. However, the cost per 3PN call out and the cost per 3PN are inversely related with the overlap, so it is a cost savings overall for the 3PI exchange system to have a high amount of overlap of competition for the same ad queries (bid requests).

In the above analysis, the model assumes a message size is around 2 KB. This is reasonable when bid responses of 3PNs are redirects. In contrast, however, if the 3PNs are sending real creatives (including gifts, etc.) back, the message size of those communications can be much larger. This will greatly increase the bandwidth-related costs, and in the extreme case, could be the bottleneck of scaling the system. It would be beneficial to decreasing the bandwidth costs and keeping the same predictable to avoid having large bid responses over 8 KB.

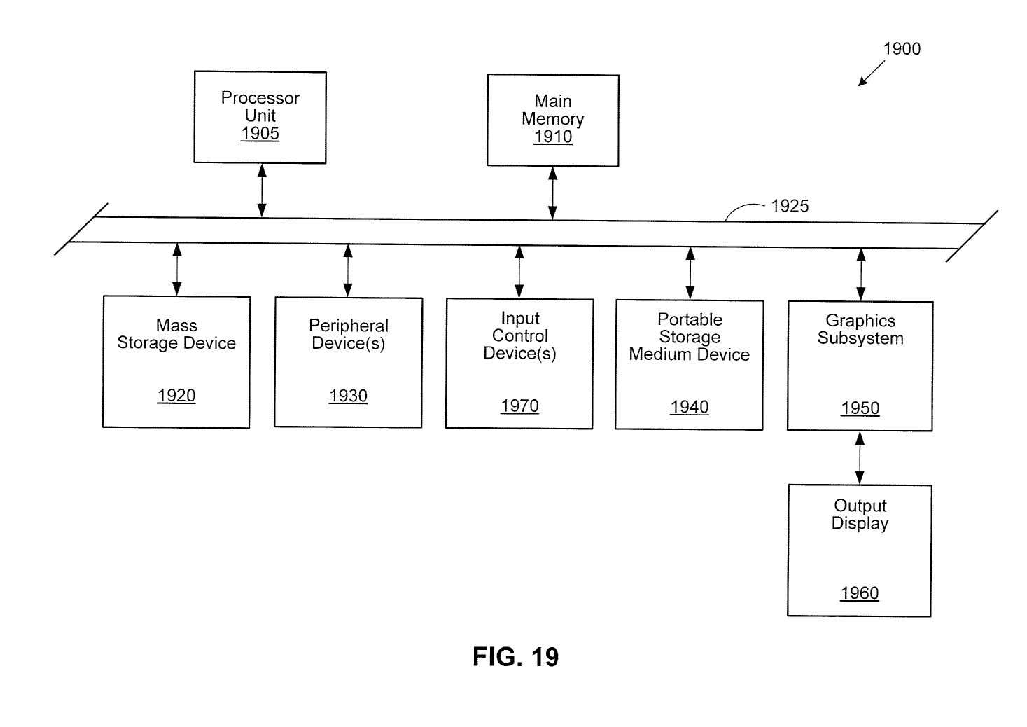

FIG. 19 illustrates a high-level block diagram of a general purpose computer system. The general purpose computer system may be a user computer or a server computer. A computer system 1900 contains a processor unit 1905, main (or system) memory 1910, and an interconnect bus 1925. The processor unit 1905 may contain a single microprocessor or may contain a plurality of microprocessors for configuring the computer system 1900 as a multi-processor system. The main memory 1910 stores, in part, instructions and data for execution by the processor unit 1905. If the online advertisement system of the present invention is partially implemented in software, the main memory 1910 stores the executable code when in operation. The main memory 1910 may include banks of dynamic random access memory (DRAM) as well as high-speed cache memory.

The computer system 1900 further includes a mass storage device 1920, peripheral device(s) 1930, portable storage medium device(s) 1940, input control device(s) 1970, a graphics subsystem 1950, and an output display 1960. For purposes of simplicity, all components in the computer system 1900 are shown in FIG. 19 as being connected via the bus 1925. However, the computer system 1900 may be connected through one or more data transport means. For example, the processor unit 1905 and the main memory 1910 may be connected via a local microprocessor bus, and the mass storage device 1920, peripheral device(s) 1930, portable storage medium device(s) 1940, and graphics subsystem 1950 may be connected via one or more input/output (I/O) busses. The mass storage device 1920, which may be implemented with a magnetic disk drive or an optical disk drive, is a non-volatile storage device for storing data and instructions for use by the processor unit 1905. In the software embodiment, the mass storage device 1920 stores the online advertisement system software for loading to the main memory 1910.

The portable storage medium drive 1940 operates in conjunction with a portable non-volatile storage medium, such as a compact disc read only memory (CD-ROM), to input and output data and code to and from the computer system 1900. In one embodiment, the online advertisement system software is stored on such a portable medium, and is input to the computer system 1900 via the portable storage medium device 1940. The peripheral device(s) 1930 may include any type of computer support device, such as an input/output (I/O) interface, to add additional functionality to the computer system 1900. For example, the peripheral device(s) 1930 may include a network interface card for interfacing the computer system 1900 to a network.

The input control device(s) 1970 provide a portion of the user interface for a user of the computer system 1900. The input control device(s) 1970 may include an alphanumeric keypad for inputting alphanumeric and other key information, a cursor control device, such as a mouse, a trackball, stylus, or cursor direction keys. In order to display textual and graphical information, the computer system 1900 contains the graphics subsystem 1950 and the output display 1960. The output display 1960 may include a cathode ray tube (CRT) display or liquid crystal display (LCD). The graphics subsystem 1950 receives textual and graphical information, and processes the information for output to the output display 1960. The components contained in the computer system 1900 are those typically found in general purpose computer systems, and in fact, these components are intended to represent a broad category of such computer components that are well known in the art.

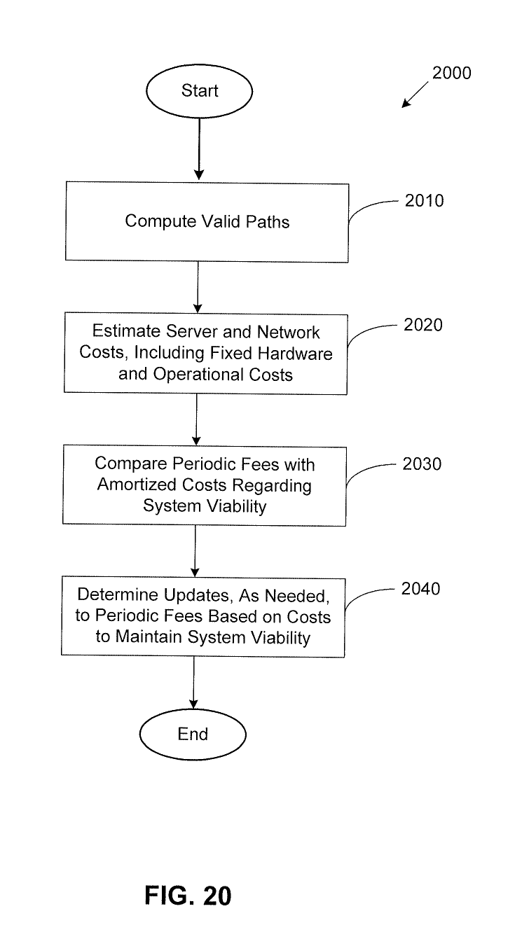

FIG. 20 is a flow diagram of a method 2000 for evaluating cost-based viability of a real-time, auction-based advertising system with third-party integration. Further to the methods of FIGS. 5-7, the method 2000 is executed by an advertising exchange server or by a computer coupled therewith. The computer is referred to for purposes of simplicity, but the exchange server itself may perform these steps as discussed above. At block 2010, the computer computes a plurality of valid paths from a plurality of publishers to and from the third-party entities through the exchange server. At block 2020, the computer estimates a plurality of server and network costs, including fixed hardware costs and variable operational costs, amortized over a predetermined period of time, based on a number of average queries per second (QPS) transmitted at different portions of the valid paths. At block 2030, the computer compares current periodic fees paid by the plurality of third-party entities or their intermediaries to the plurality of amortized costs, to determine cost-based system viability. At block 2040, the computer determines updates, if needed, to the periodic fees based on the plurality of costs to maintain cost-based system viability.

The system and process described may be encoded in a signal bearing medium, a computer readable medium such as a memory, programmed within a device such as one or more integrated circuits, one or more processors or processed by a controller or a computer. If the methods are performed by software, the software may reside in a memory resident or interfaced to a storage device, synchronizer, a communication interface, or non-volatile or volatile memory in communication with a transmitter. A circuit or electronic device may be designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal, or a combination thereof. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “computer-readable storage medium,” “machine-readable medium,” “propagated-signal” medium, and/or “signal-bearing medium” may include any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A computer-implemented modeling system to evaluate cost-based viability of a real-time, auction-based advertising system with third-party integration, the modeling system comprising:
an exchange server comprising a processor and system memory configured to:
receive a request for an advertisement (“ad”) bid from a publisher Web page;
apply one or more business rules to determine a plurality of third-party entities that qualify to serve the advertisement;
transmit a plurality of requests for bids to the third-party entities;
receive at least one bid and corresponding advertisement from the third-party entities in response to the requests for bids; and
select an advertisement based on the at least one bid and corresponding advertisement to deliver to the publisher Web page in real time;
a computer coupled with the exchange server, the computer having a processor and system memory, the computer configured to:
compute a plurality of valid paths from a plurality of publishers to and from the third- party entities, and through the exchange server;
estimate a plurality of server and network costs, including fixed hardware costs and variable operational costs, amortized over a predetermined period of time, based on a number of average queries per second (QPS) transmitted at different portions of the valid paths;
compare current periodic fees paid by the plurality of third-party entities to the plurality of amortized costs, to determine cost-based system viability; and
determine updates, if needed, to the periodic fees based on the plurality of costs to maintain cost-based system viability.

2. The modeling system of claim 1, further comprising:
a bid gateway server comprising a processor and system memory coupled with the exchange server, the bid gateway server configured to:
receive the requests for bids from the exchange server;
configure a third-party bid request for each entity identified in the requests for bids;
transmit the third-party bid requests to a third-party entity;
collect at least one bid and corresponding ad from the third-party entity; and
transmit the at least one bid and corresponding ad to the exchange server.

3. The modeling system of claim 2, wherein the valid paths include the bid gateway server inserted between the exchange server and the plurality of third-party entities, wherein the computer further configured to:
determine whether additional exchange servers or bid gateway servers are needed to support the queries per second (QPS) rates based on at least the number of average QPS transmitted at different portions of the valid paths; and
include amortized upfront and operational costs of any additional exchange server or bid gateway in the estimated server costs.

4. The modeling system of claim 2, further comprising:
networking hardware coupled with the exchange server and the bid gateway server, to pass bid requests and bids to and from the exchange server and the bid gateway server, wherein the valid paths include the networking hardware, and wherein the computer determines whether additional networking hardware is needed as part of its network cost estimation.

5. The modeling system of claim 2, wherein the computer is configured to update computation of the plurality of costs and third-party entity fees periodically, based on changing market conditions reflected in changing average queries per second (QPS) along the valid paths.

6. The modeling system of claim 2, wherein the computer is configured to calculate a sum of incoming and outgoing queries per second (QPS) of the bid gateway server to characterize peak performance thereof.

7. The modeling system of claim 6, wherein an exchange entity that owns the exchange server advertises to the third-party recipients the availability of certain high-value bid requests, in order to drive up competition therefor, thus creating higher participation overlap in bidding for the high-value bid requests, which enables support of higher peak queries per second (QPS) by the bid gateway server.

8. The modeling system of claim 4, wherein the plurality of costs include bandwidth costs, wherein the computer is configured to:
calculate a first latency for communicating at a first queries per second (QPS) between the exchange server and the bid gateway server along valid paths of a bid request;
calculate a second latency for communicating at a second QPS between the bid gateway server and the third-party recipients along valid paths for a response to the bid request; and
sum the first and second latencies to determine a total, end-to-end latency for the bid request, wherein the first latency is associated with a first, lower bandwidth cost and the second latency is associated with a second, higher bandwidth cost, and wherein the end-to-end latency comprises a nonlinear function of incoming QPS for respective portions of the valid paths.

9. A computer-implemented method for evaluating cost-based viability of a real-time, auction-based advertising system with third-party integration, the method comprising:
executing the following steps by an exchange server that includes a processor and system memory:
receiving a request for an advertisement (“ad”) bid from a publisher Web page;
applying one or more business rules to determine a plurality of third-party entities who qualify to serve the advertisement;
transmitting a plurality of requests for bids to the third-party entities;
receiving at least one bid and corresponding advertisement from the third-party entities in response to the requests for bids; and
selecting an advertisement based on the at least one bid and corresponding advertisement to deliver to the publisher Web page in real time;
executing the following steps by a computer coupled with the exchange server, the computer including a processor and system memory:
computing a plurality of valid paths from a plurality of publishers to and from the third-party entities through the exchange server;
estimating a plurality of server and network costs, including fixed hardware costs and variable operational costs, amortized over a predetermined period of time, based on a number of average queries per second (QPS) transmitted at different portions of the valid paths;
comparing current periodic fees paid by the plurality of third-party entities or their intermediaries to the plurality of amortized costs, to determine cost-based system viability; and
determining updates, if needed, to the periodic fees based on the plurality of costs to maintain cost-based system viability.

10. The method of claim 9, further comprising, by a bid gateway server coupled with exchange server:
receiving the requests for bids from the exchange server;
configuring a third-party bid request for each entity identified in the requests for bids;
transmitting the third-party bid requests to a third-party entity;
collecting at least one bid and corresponding ad from the third-party entity; and
transmitting the at least one bid and corresponding ad to the exchange server.

11. The method of claim 10, wherein the valid paths include the bid gateway server inserted between the exchange server and the plurality of third-party entities, further comprising:
determining, by the computer, whether additional exchange servers or bid gateway servers are needed to support the queries per second (QPS) rates based on at least the number of average QPS transmitted at different portions of the valid paths; and
including amortized upfront and operational costs of any additional exchange server or bid gateway in the estimated server costs.

12. The method of claim 10, wherein the valid paths include networking hardware coupled with the exchange server and the bid gateway server to pass bid requests and bids therebetween, the method further comprising:
determining, by the computer, whether additional networking hardware is needed as part of its network cost estimation.

13. The method of claim 10, further comprising:
updating, by the computer, computation of the plurality of costs and third-party entity fees periodically, based on changing market conditions reflected in changing average queries per second (QPS) along the valid paths.

14. The method of claim 10, further comprising:
calculating, by the computer, a sum of incoming and outgoing queries per second (QPS) of the bid gateway server to characterize peak performance thereof.

15. The method of claim 14, further comprising:
advertising, an exchange entity that owns the exchange server, to third-party recipients, the availability of certain high-value bid requests, to drive up competition therefor, thus creating higher participation overlap in bidding for the high-value bid requests, which enables support of higher peak queries per second (QPS) by the bid gateway server.

16. The method of claim 12, wherein the plurality of costs include bandwidth costs, the method further comprising, by the computer:
calculating a first latency for communicating at a first queries per second (QPS) between the exchange server and the bid gateway server along valid paths of a bid request;
calculating a second latency for communicating at a second QPS between the bid gateway server and the third-party recipients along valid paths for a response to the bid request; and
summing the first and second latencies to determine a total, end-to-end latency for the bid request, wherein the first latency is associated with a first, lower bandwidth cost, and the second latency is associated with a second, higher bandwidth cost, and wherein the end-to-end latency comprises a nonlinear function of incoming QPS for respective portions of the valid paths.

17. A computer readable storage medium comprising a set of instructions, the set of instructions to direct a processor to perform the acts of:
receiving, by an exchange server, a request for an advertisement (“ad”) bid from a publisher Web page;
applying one or more business rules to determine a plurality of third-party entities that qualify to serve the advertisement;
transmitting a plurality of requests for bids to the third-party entities;
receiving at least one bid and corresponding advertisement from the third-party entities in response to the requests for bids;
selecting an advertisement based on the at least one bid and corresponding advertisement to deliver to the publisher Web page in real time;
computing a plurality of valid paths from a plurality of publishers to and from the third-party entities through the exchange server;
estimating a plurality of server and network costs, including fixed hardware costs and variable operational costs, amortized over a predetermined period of time, based on a number of average queries per second (QPS) transmitted at different portions of the valid paths;
comparing current periodic fees paid by the plurality of third-party entities to the plurality of amortized costs, to determine cost-based system viability; and
determining updates, if needed, to the periodic fees based on the plurality of costs to maintain cost-based system viability.

18. The computer-readable storage medium of claim 17, further comprising a set of instructions to direct the processor to perform the acts of:
receiving, by a bid gateway server coupled with the exchange server, the requests for bids from the exchange server;
configuring a third-party bid request for each entity identified in the requests for bids;
transmitting the third-party bid requests to a third-party entity;
collecting at least one bid and corresponding ad from the third-party entity; and
transmitting the at least one bid and corresponding ad to the exchange server.

19. The computer-readable storage medium of claim 18, wherein the valid paths include the bid gateway server inserted between the exchange server and the plurality of third-party entities, further comprising a set of instructions to direct the processor to perform the acts of:
determining whether additional exchange servers or bid gateway servers are needed to support the queries per second (QPS) rates based on at least the number of QPS transmitted at different portions of the valid paths; and
including amortized upfront and operational costs of any additional exchange server or bid gateway in the estimated server costs.

20. The computer-readable storage medium of claim 18, wherein the valid paths include networking hardware coupled with the exchange server and the bid gateway server, to pass bid requests and bids therebetween, further comprising a set of instructions to direct the processor to perform the acts of:
determining whether additional networking hardware is needed as part of its network cost estimation.

21. The computer-readable storage medium of claim 18, further comprising a set of instructions to direct the processor to perform the acts of:
updating computation of the plurality of costs and third-party entity fees periodically, based on changing market conditions reflected in changing average queries per second (QPS) along the valid paths.

22. The computer-readable storage medium of claim 18, further comprising a set of instructions to direct the processor to perform the acts of:
calculating a sum of incoming and outgoing queries per second (QPS) of the bid gateway server to characterize peak performance thereof.

23. The computer-readable storage medium of claim 20, wherein the plurality of costs include bandwidth costs, further comprising a set of instructions to direct the processor to perform the acts of:
calculating a first latency for communicating at a first queries per second (QPS) between the exchange server and the bid gateway server along valid paths of a bid request;
calculating a second latency for communicating at a second QPS between the bid gateway server and the third-party recipients along valid paths for a response to the bid request; and
summing the first and second latencies to determine a total, end-to-end latency for the bid request, wherein the first latency is associated with a first, lower bandwidth cost and the second latency is associated with a second, higher bandwidth cost, wherein the end-to-end latency comprises a nonlinear function of incoming QPS for respective portions of the valid paths.
